(19) United States
(12) Patent Application Publication
(10) Pub. No.: US 2020/0090087 A1
(43) Pub. Date: Mar. 19, 2020

(54) DYNAMIC REAL-TIME FEEDBACK FOR AGENTS

(71) Applicant: ServiceNow, Inc., Santa Clara, CA (US)

(72) Inventor: Manjeet Singh, Rewari (IN)

(21) Appl. No.: 16/132,709

(22) Filed: Sep. 17, 2018

(51) Int. Cl. G06Q 10/06; G06Q 10/10; G06F 9/451; H04L 29/08; H04L 12/24

(52) U.S. Cl. CPC G06Q 10/0633; G06Q 10/06398; G06Q 10/06316; G06Q 10/063114; H04L 41/0213; G06F 9/453; H04L 67/306; H04L 41/046; G06Q 10/103

(57) ABSTRACT

A system may include a database storing: (i) a definition of a multi-state incident management workflow, and (ii) incidents related to a managed network, where the incidents are assigned to one state of the workflow at any particular time. The system may also include a processor configured to: determine that a particular incident has entered, is in, or has left a pre-defined target state of the workflow, where an agent has been assigned to perform, for the particular incident, operations associated with the pre-defined target state; responsively compare values, for the incident, one or more state variables related to the pre-defined target state to: (i) historical values or (ii) threshold values; determine that the values of the state variables are outside of a range of values derived from the historical values or threshold values; and responsively based on a profile of the agent, provide feedback to the agent.

### BACKGROUND

Enterprise software applications may be used to implement workflows. These applications may include a desktop or web-based interface for usage by employees (e.g., an agent) of the enterprise. A workflow may include one or more states that involve operations performed by these users. As such, an agent may employ an application to perform the operations to achieve a desired outcome. For example, one type of application may enable agents, such as information technology (IT) professionals, to address reported issues by performing operations defined by a workflow for IT service management.

### SUMMARY

When an agent employs a software application to perform a work item according to a workflow, the application may direct the agent to perform certain operations. For example, the agent may be given operations that include providing the application with information, performing analyses, and determining issue resolutions. Many operations may require the agent to enter input into the application. This input may be used to perform other operations of the workflow. For example, a problem diagnosis entered by the agent may be used to determine remedial operations to fix the problem.

Accordingly, the operations carried out by the user as well as the user input may be critical to successfully perform the work item. Providing the application with accurate information may also be critical for future utility of records created by the application. For instance, the software application may store a record of each use of the application. Such records may be useful as historical data (e.g., for purposes of data analysis), and thus, it is important for the records to be accurate.

Despite this observation, current software applications do not include functionalities that evaluate an agent's performance of assigned operations in order to ensure that operations are performed correctly. For instance, if the agent incorrectly performs an operation, the software often does not inform the agent or the agent's supervisor of the incorrectly performed operation. And even if the supervisor becomes aware of the mistake, current applications do not include a functionality that allows the supervisor to rapidly provide feedback to the agent in order to remedy the mistake or to prevent the mistake from occurring again in the future. As a result, supervisors typically wait until a yearly employee appraisal period to provide feedback to the agent. By that time, the feedback is not timely or contextual, and thus is often ineffective.

Additionally, current software applications do not provide the user with resources that may assist the user when performing assigned operations. Often, the only resource that is available is general help documentation for the application, which may not provide the user with a desired level of nuance and specificity. Thus, in practice, if the user encounters any difficulties when performing the operations, the user may inefficiently spend a long period of time resolving the difficulties or may incorrectly perform the assigned operations.

Disclosed herein are systems and methods for providing feedback to a user that is performing a work item in accordance with a workflow. The workflow may be an IT service management (ITSM), customer service management (CSM), or a human resources (HR) workflow, among other workflows. In an embodiment, a supervisor may define feedback moments or opportunities in the workflow for which the supervisor may provide feedback. Specifically, the feedback moments may occur in situations where it may be useful to provide the user with feedback. In an example, a feedback moment may occur when the user may have incorrectly performed operations. Such a scenario may occur when a work item transitions from a first state to another without the operations of the first state being complete, or when a state is reopened after having been completed. In another example, a feedback moment may occur when the user may need instructions or assistance. This scenario may occur when a length of time that the user spends in a state exceeds a threshold time.

When a feedback moment occurs, the operations associated with the feedback moment (i.e., operations that triggered the feedback moment) are flagged for review. The operations may be reviewed by an assigned reviewer, which may be a virtual reviewer or a human reviewer. Subsequently, the reviewer may generate feedback for the user. In order for the feedback to be contextual and individualized, the feedback may be generated based on a profile of the user and values of variables associated with the flagged operations.

The generated feedback may take various forms, perhaps depending on the feedback moment. In an example, if the feedback moment is a scenario in which the user has incorrectly performed operations, then the feedback may include training information that explains how to correctly perform the operations. In another example, if the feedback moment is a scenario in which the user needs assistance or instructions, then the feedback may include the assistance needed by the user.

Because the feedback that is provided to the user is timely and contextual, the feedback provided may be more effective than what is traditionally provided in annual reviews. In addition to improving employee performance, other benefits of providing timely and contextual feedback include reinforcing best practices and improving employee satisfaction and engagement.

Accordingly, a first example embodiment may involve a computational instance of a remote network management platform, the computational instance comprising: a database storing: (i) a definition of a multi-state incident management workflow carried out in relation to a managed network, and (ii) incidents related to the managed network, wherein the incidents are assigned to one state of the incident management workflow at any particular time, and wherein the computational instance is dedicated to the managed network. The computational instance also includes one or more computing devices configured to: determine that a particular incident of the incidents has entered, is in, or has left a pre-defined target state of the incident management workflow, wherein an agent associated with the managed network has been assigned to perform, for the particular incident, operations associated with the pre-defined target state. The one or more computing devices are also configured to responsively compare values, for the incident, of one or more state variables related to the pre-defined target state to: (i) historical values, for the incidents related to the managed network, of the one or more state variables, or (ii) threshold values of the one or more state variables. Further, the one or more computing devices are configured to determine that the values of the one or more state variables are outside of a range of values derived from the historical values or the threshold values. Yet further, the one or more computing devices are configured to, based on a profile of the agent and the values of the one or more state variables being outside of the range of values, provide to the agent a reference to information that represents pre-defined practice guidelines for the operations associated with the pre-defined target state.

A second example embodiment may involve identifying a pre-defined target state of a multi-state incident management workflow carried out in relation to a managed network, wherein a definition of the multi-state incident management workflow is stored in a database, wherein the database further stores incidents related to the managed network, and wherein the incidents are assigned to one state of the incident management workflow at any particular time. The embodiment may also involve determining that a particular incident of the incidents has entered, is in, or has left the pre-defined target state of the incident management workflow, wherein an agent associated with the managed network has been assigned to perform, for the particular incident, operations associated with the pre-defined target state. Additionally the embodiment may involve responsively comparing values, for the incident, of one or more state variables related to the pre-defined target state to: (i) historical values, for the incidents related to the managed network, of the one or more state variables, or (ii) threshold values of the one or more state variables. Further, the embodiment may involve determining that the values of the one or more state variables are outside of a range of values derived from the historical values or the threshold values. Yet further, the embodiment may involve, based on a profile of the agent and the values of the one or more state variables being outside of the range of values, providing to the agent a reference to information that represents pre-defined practice guidelines for the operations associated with the pre-defined target state.

In a third example embodiment, an article of manufacture may include a non-transitory computer-readable medium, having stored thereon program instructions that, upon execution by a computing system, cause the computing system to perform operations in accordance with the first and/or second example embodiments.

In a fourth example embodiment, a computing system may include at least one processor, as well as memory and program instructions. The program instructions may be stored in the memory, and upon execution by the at least one processor, cause the computing system to perform operations in accordance with the first and/or second example embodiments.

In a fifth example embodiment, a system may include various means for carrying out each of the operations of the first and/or second example embodiments.

These as well as other embodiments, aspects, advantages, and alternatives will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5A depicts another communication environment involving a remote network management architecture, in accordance with example embodiments.

FIG. 5B is a flow chart, in accordance with example embodiments.

FIG. 6A depicts a multi-step workflow, in accordance with example embodiments.

FIG. 6B depicts another multi-step workflow, in accordance with example embodiments.

FIG. 7A illustrates a schematic drawing of a computing system and client devices, in accordance with example embodiments.

FIG. 7B illustrates communication between a computing system and client devices, in accordance with example embodiments.

FIG. 7C illustrates further communication between a computing system and client devices, in accordance with example embodiments.

FIG. 8A depicts a graphical user interface for creating a new feedback moment, in accordance with example embodiments.

FIG. 8B depicts a graphical user interface for creating a new recommended learning path, in accordance with example embodiments.

FIGS. 9A, 9B, 9C, 9D, 9E, and 9F each depict a graphical user interface of a feedback application, in accordance with example embodiments.

FIG. 10 illustrates a schematic drawing of a computing system, in accordance with example embodiments.

FIG. 11 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflow for IT, HR, CRM, customer service, application development, and security.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, delete (CRUD) capabilities. This allows new applications to be built on a common application infrastructure.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data is stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional MVC application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

The following embodiments describe architectural and functional aspects of example aPaaS systems, as well as the features and advantages thereof.

### II. Example Computing Devices and Cloud-Based Computing Environments

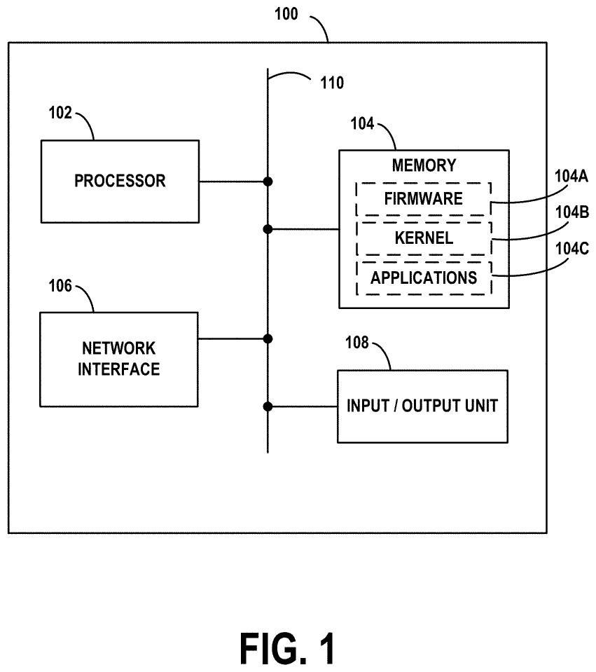

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and an input/output unit 108, all of which may be coupled by a system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/ output, and communication. Kernel 104B may also include device drivers that allow the operating system to communicate with the hardware modules (e.g., memory units, networking interfaces, ports, and busses), of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more instances of computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

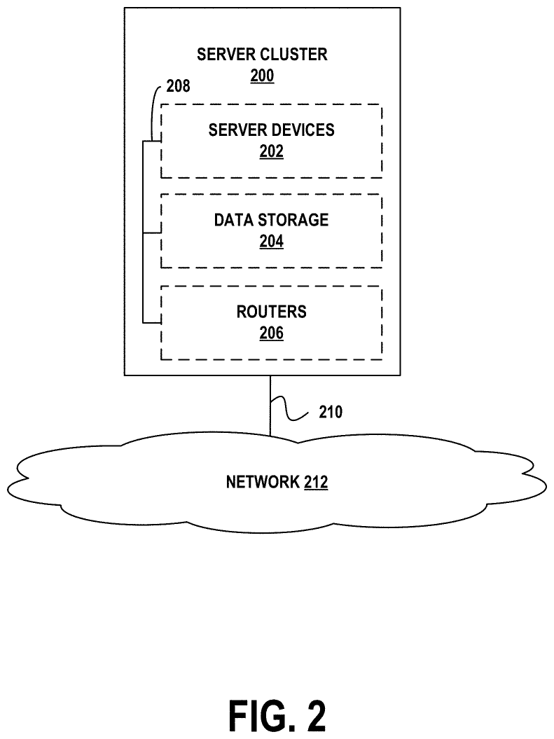

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purpose of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between the server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JavaScript, and so on. Computer program code written in these languages may facilitate the providing of web pages to client devices, as well as client device interaction with the web pages.

### III. Example Remote Network Management Architecture

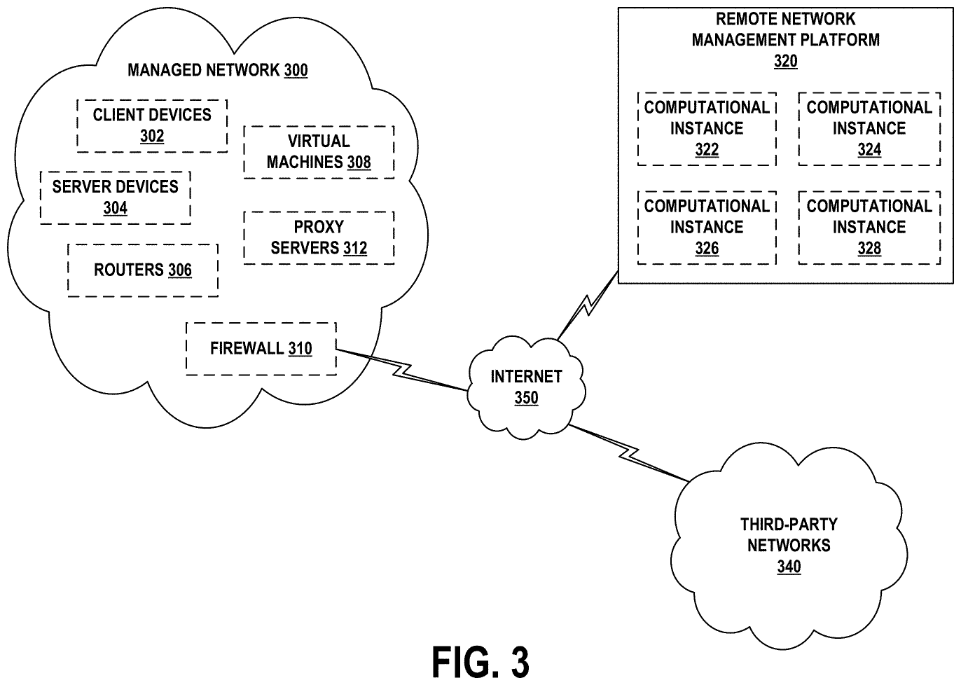

FIG. 3 depicts a remote network management architecture, in accordance with example embodiments. This architecture includes three main components, managed network 300, remote network management platform 320, and third-party networks 340, all connected by way of Internet 350.

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server device that facilitates communication and movement of data between managed network 300, remote network management platform 320, and third-party networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components. Possibly with the assistance of proxy servers 312, remote network management platform 320 may also be able to discover and manage aspects of third-party networks 340 that are used by managed network 300.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

Remote network management platform 320 is a hosted environment that provides aPaaS services to users, particularly to the operators of managed network 300. These services may take the form of web-based portals, for instance. Thus, a user can securely access remote network management platform 320 from, for instance, client devices 302, or potentially from a client device outside of managed network 300. By way of the web-based portals, users may design, test, and deploy applications, generate reports, view analytics, and perform other tasks.

As shown in FIG. 3, remote network management platform 320 includes four computational instances 322, 324, 326, and 328. Each of these instances may represent a set of web portals, services, and applications (e.g., a wholly-functioning aPaaS system) available to a particular customer. In some cases, a single customer may use multiple computational instances. For example, managed network 300 may be an enterprise customer of remote network management platform 320, and may use computational instances 322, 324, and 326. The reason for providing multiple instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation.

The multi-instance architecture of remote network management platform 320 is in contrast to conventional multi-tenant architectures, over which multi-instance architectures have several advantages. In multi-tenant architectures, data from different customers (e.g., enterprises) are comingled in a single database. While these customers' data are separate from one another, the separation is enforced by the software that operates the single database. As a consequence, a security breach in this system may impact all customers' data, creating additional risk, especially for entities subject to governmental, healthcare, and/or financial regulation. Furthermore, any database operations that impact one customer will likely impact all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In order to support multiple computational instances in an efficient fashion, remote network management platform 320 may implement a plurality of these instances on a single hardware platform. For example, when the aPaaS system is implemented on a server cluster such as server cluster 200, it may operate a virtual machine that dedicates varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

Third-party networks 340 may be remote server devices (e.g., a plurality of server clusters such as server cluster 200) that can be used for outsourced computational, data storage, communication, and service hosting operations. These servers may be virtualized (i.e., the servers may be virtual machines). Examples of third-party networks 340 may include AMAZON WEB SERVICES® and MICROSOFT® Azure. Like remote network management platform 320, multiple server clusters supporting third-party networks 340 may be deployed at geographically diverse locations for purposes of load balancing, redundancy, and/or high availability.

Managed network 300 may use one or more of third-party networks 340 to deploy applications and services to its clients and customers. For instance, if managed network 300 provides online music streaming services, third-party networks 340 may store the music files and provide web interface and streaming capabilities. In this way, the enterprise of managed network 300 does not have to build and maintain its own servers for these operations.

Remote network management platform 320 may include modules that integrate with third-party networks 340 to expose virtual machines and managed services therein to managed network 300. The modules may allow users to request virtual resources and provide flexible reporting for third-party networks 340. In order to establish this functionality, a user from managed network 300 might first establish an account with third-party networks 340, and request a set of associated resources. Then, the user may enter the account information into the appropriate modules of remote network management platform 320. These modules may then automatically discover the manageable resources in the account, and also provide reports related to usage, performance, and billing.

Internet 350 may represent a portion of the global Internet. However, Internet 350 may alternatively represent a different type of network, such as a private wide-area or local-area packet-switched network.

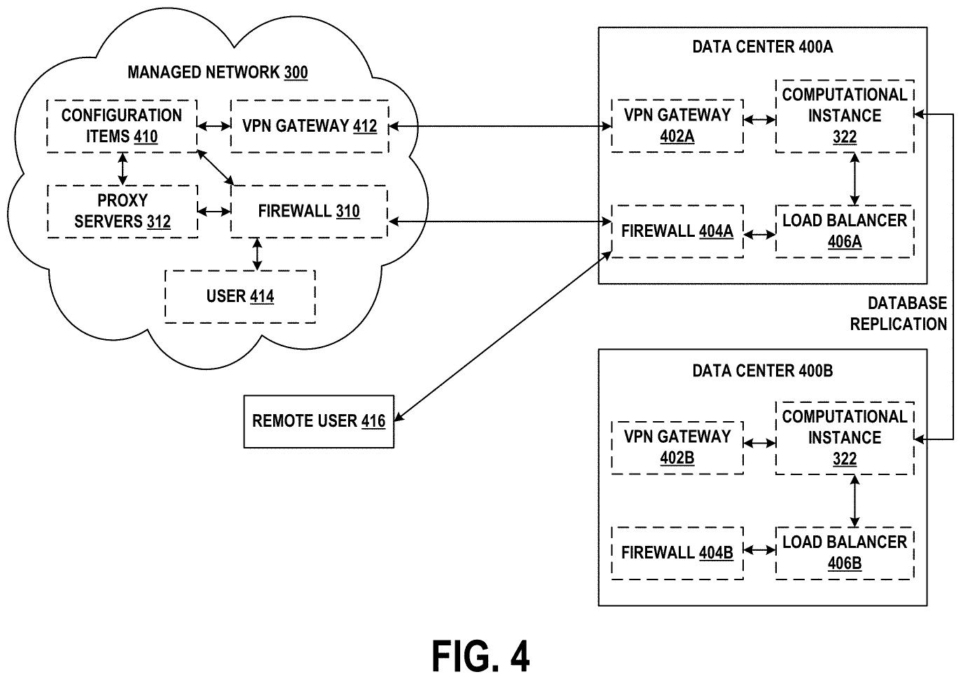

FIG. 4 further illustrates the communication environment between managed network 300 and computational instance 322, and introduces additional features and alternative embodiments. In FIG. 4, computational instance 322 is replicated across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any applications or services executing thereon, as well as relationships between devices, applications, and services. Thus, the term “configuration items” may be shorthand for any physical or virtual device, or any application or service remotely discoverable or managed by computational instance 322, or relationships between discovered devices, applications, and services. Configuration items may be represented in a configuration management database (CMDB) of computational instance 322.

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively).

### IV. Example Device, Application, and Service Discovery

In order for remote network management platform 320 to administer the devices, applications, and services of managed network 300, remote network management platform 320 may first determine what devices are present in managed network 300, the configurations and operational statuses of these devices, and the applications and services provided by the devices, and well as the relationships between discovered devices, applications, and services. As noted above, each device, application, service, and relationship may be referred to as a configuration item. The process of defining configuration items within managed network 300 is referred to as discovery, and may be facilitated at least in part by proxy servers 312.

For purpose of the embodiments herein, an “application” may refer to one or more processes, threads, programs, client modules, server modules, or any other software that executes on a device or group of devices. A “service” may refer to a high-level capability provided by multiple applications executing on one or more devices working in conjunction with one another. For example, a high-level web service may involve multiple web application server threads executing on one device and accessing information from a database application that executes on another device.

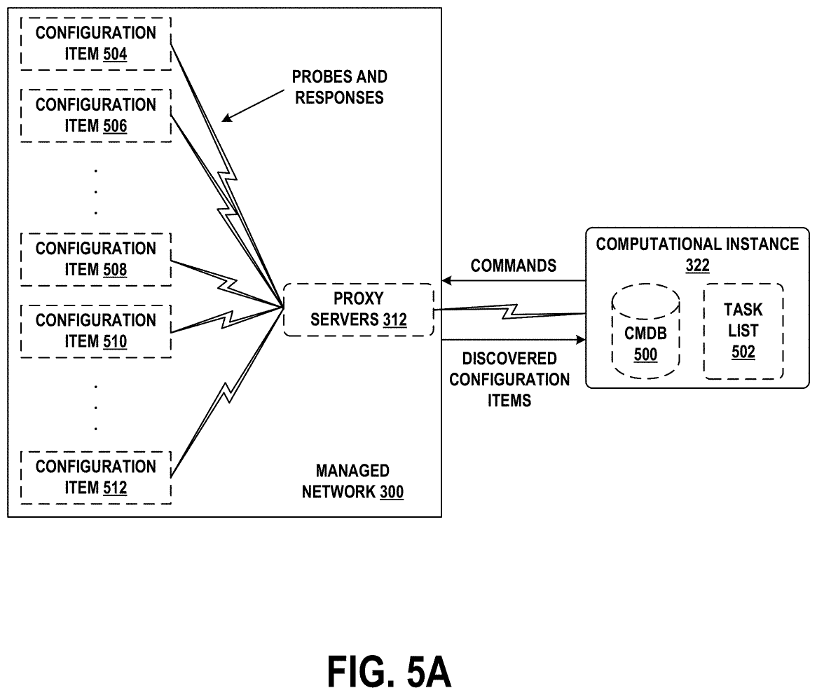

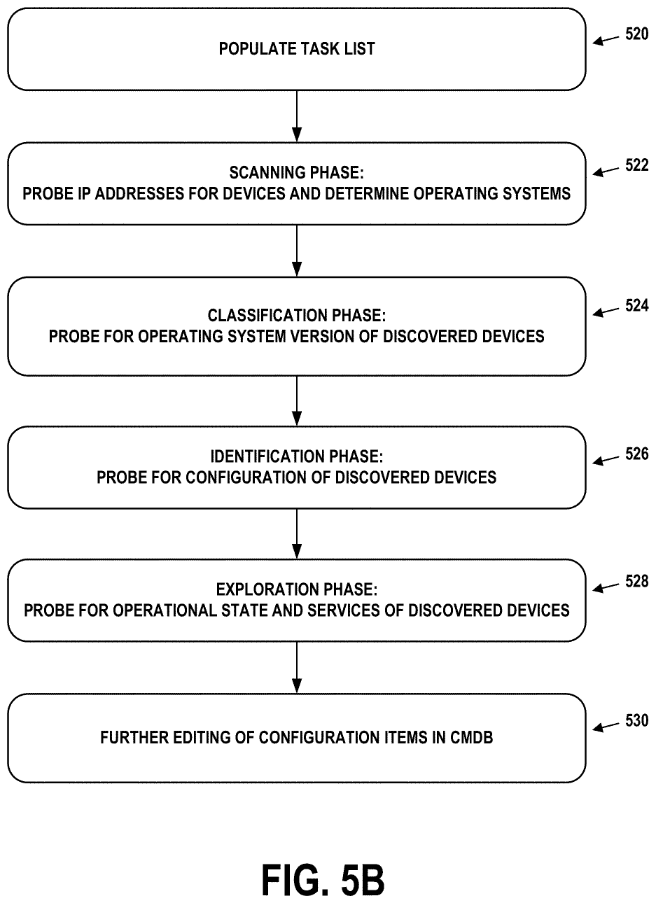

FIG. 5A provides a logical depiction of how configuration items can be discovered, as well as how information related to discovered configuration items can be stored. For sake of simplicity, remote network management platform 320, third-party networks 340, and Internet 350 are not shown.

In FIG. 5A, CMDB 500 and task list 502 are stored within computational instance 322. Computational instance 322 may transmit discovery commands to proxy servers 312. In response, proxy servers 312 may transmit probes to various devices, applications, and services in managed network 300. These devices, applications, and services may transmit responses to proxy servers 312, and proxy servers 312 may then provide information regarding discovered configuration items to CMDB 500 for storage therein. Configuration items stored in CMDB 500 represent the environment of managed network 300.

Task list 502 represents a list of activities that proxy servers 312 are to perform on behalf of computational instance 322. As discovery takes place, task list 502 is populated. Proxy servers 312 repeatedly query task list 502, obtain the next task therein, and perform this task until task list 502 is empty or another stopping condition has been reached.

To facilitate discovery, proxy servers 312 may be configured with information regarding one or more subnets in managed network 300 that are reachable by way of proxy servers 312. For instance, proxy servers 312 may be given the IP address range 192.168.0/24 as a subnet. Then, computational instance 322 may store this information in CMDB 500 and place tasks in task list 502 for discovery of devices at each of these addresses.

FIG. 5A also depicts devices, applications, and services in managed network 300 as configuration items 504, 506, 508, 510, and 512. As noted above, these configuration items represent a set of physical and/or virtual devices (e.g., client devices, server devices, routers, or virtual machines), applications executing thereon (e.g., web servers, email servers, databases, or storage arrays), relationships therebetween, as well as services that involve multiple individual configuration items.

Placing the tasks in task list 502 may trigger or otherwise cause proxy servers 312 to begin discovery. Alternatively or additionally, discovery may be manually triggered or automatically triggered based on triggering events (e.g., discovery may automatically begin once per day at a particular time).

In general, discovery may proceed in four logical phases: scanning, classification, identification, and exploration. Each phase of discovery involves various types of probe messages being transmitted by proxy servers 312 to one or more devices in managed network 300. The responses to these probes may be received and processed by proxy servers 312, and representations thereof may be transmitted to CMDB 500. Thus, each phase can result in more configuration items being discovered and stored in CMDB 500.

In the scanning phase, proxy servers 312 may probe each IP address in the specified range of IP addresses for open Transmission Control Protocol (TCP) and/or User Datagram Protocol (UDP) ports to determine the general type of device. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist. Once the presence of a device at a particular IP address and its open ports have been discovered, these configuration items are saved in CMDB 500.

In the classification phase, proxy servers 312 may further probe each discovered device to determine the version of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise if a device was classified as WINDOWS® 2012, as a set of WINDOWS®-2012-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (applications), and so on. Once more, the discovered information may be stored as one or more configuration items in CMDB 500.

Running discovery on a network device, such as a router, may utilize SNMP. Instead of or in addition to determining a list of running processes or other application-related information, discovery may determine additional subnets known to the router and the operational state of the router's network interfaces (e.g., active, inactive, queue length, number of packets dropped, etc.). The IP addresses of the additional subnets may be candidates for further discovery procedures. Thus, discovery may progress iteratively or recursively.

Once discovery completes, a snapshot representation of each discovered device, application, and service is available in CMDB 500. For example, after discovery, operating system version, hardware configuration and network configuration details for client devices, server devices, and routers in managed network 300, as well as applications executing thereon, may be stored. This collected information may be presented to a user in various ways to allow the user to view the hardware composition and operational status of devices, as well as the characteristics of services that span multiple devices and applications.

Furthermore, CMDB 500 may include entries regarding dependencies and relationships between configuration items. More specifically, an application that is executing on a particular server device, as well as the services that rely on this application, may be represented as such in CMDB 500. For instance, suppose that a database application is executing on a server device, and that this database application is used by a new employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular router fails.

In general, dependencies and relationships between configuration items may be displayed on a web-based interface and represented in a hierarchical fashion. Thus, adding, changing, or removing such dependencies and relationships may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in single operation.

In order for discovery to take place in the manner described above, proxy servers 312, CMDB 500, and/or one or more credential stores may be configured with credentials for one or more of the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

The discovery process is depicted as a flow chart in FIG. 5B. At block 520, the task list in the computational instance is populated, for instance, with a range of IP addresses. At block 522, the scanning phase takes place. Thus, the proxy servers probe the IP addresses for devices using these IP addresses, and attempt to determine the operating systems that are executing on these devices. At block 524, the classification phase takes place. The proxy servers attempt to determine the operating system version of the discovered devices. At block 526, the identification phase takes place. The proxy servers attempt to determine the hardware and/or software configuration of the discovered devices. At block 528, the exploration phase takes place. The proxy servers attempt to determine the operational state and applications executing on the discovered devices. At block 530, further editing of the configuration items representing the discovered devices and applications may take place. This editing may be automated and/or manual in nature.

The blocks represented in FIG. 5B are for purpose of example. Discovery may be a highly configurable procedure that can have more or fewer phases, and the operations of each phase may vary. In some cases, one or more phases may be customized, or may otherwise deviate from the exemplary descriptions above.

### V. Multistate Workflow

As explained above, agents of a managed network may employ software applications to perform work items in IT, HR, CRM, customer service, application development, and security. An example software application is a workflow management application. Generally, a workflow management application may manage, monitor, and automate a sequence of operations that are defined by a workflow. Performing the sequence of operations may achieve or produce a desired function, such as resolving an incident reported to the enterprise.

An agent of the managed network 300 may employ a workflow management application to perform a work item that is related to a workflow. For instance, the agent may use the application to perform a work item assigned to the agent. For example, the agent may use a workflow management application to receive, analyze, and resolve an incident. In this example, the workflow management application may be related to an incident management workflow.

In some examples, a workflow may be arranged as a sequence of states, where each state may be respectively representative of operations to be performed in that state. In such examples, a work item (that is being resolved using a multi-state workflow) may be assigned to one state at any particular time. In particular, the work item may be assigned to a first state of the workflow in response to a triggering event, such as an incident, record, report, or other event that causes the work item to be created, a work item inserted into a specific table, or a particular field in a table set to a specified value. When the operations of the first state are completed, the work item may transition to the next state of the workflow, and so on, until an exit or completion state is reached. Note that a particular state may have several different possible transitions to various states, perhaps depending on the outcome of the particular state.

Within examples, some states may include operations to be performed by the agent. The agent, who may be employing a workflow management application to perform a work item, may receive an indication, perhaps by way of a graphical user interface of the application, of the operations. Additionally and/or alternatively, the graphical user interface may include fields that enable the agent to enter information related to the operations.

Furthermore, each state of a multi-state workflow may include one or more state variables. A state variable may be a data variable that describes operations of the state or the results thereof. Additionally and/or alternatively, a state variable may be a performance variable that is related to performance of operations of the state. When a work item is being performed, the state variables of the states of the workflow may be assigned particular values, perhaps by the agent or by the application.

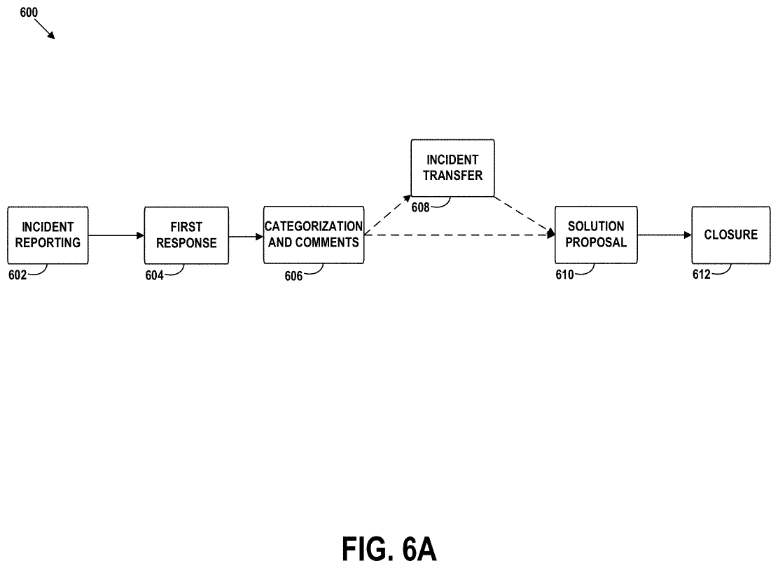

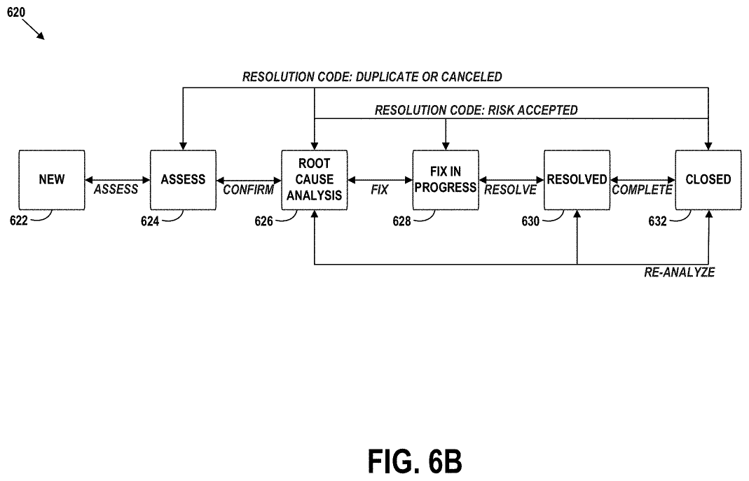

FIG. 6A illustrates a multi-state workflow 600, according to an example embodiment. The multi-state workflow 600 may be an incident management workflow for resolving an incident that is reported to the enterprise. In particular, the remote network management platform 320 may provide a service that allows users to report issues with configuration items of the managed network 300, perhaps by using a client device to submit a trouble ticket or help request via a desktop or web-based application associated with the remote network management platform 320. Once the issue is reported to the remote network management platform 320, agents of the managed network 300 may employ an application that implements the multi-state workflow 600 in order to resolve the incident.

As shown in FIG. 6A, a first state of the multi-state workflow 600 may be referred to as “incident reporting” 602. In this state, an incident record that includes information related to the reported issue may be created, perhaps in response to receiving an issue or complaint. For instance, the remote network management platform 320 may automatically generate the incident record upon receipt of certain information from a user related to the issue (e.g., receipt of a trouble ticket or help request). Additionally and/or alternatively, an agent or other authorized administrator may generate the incident record via the workflow management application or the like.

Further, an incident record can take the form of a set of data that represents a variety of information, or “components,” associated with a reported issue. Such components can include, for example: (i) an identifier of a user reporting the issue (e.g., the user's name, or a unique string of characters associated with the user), (ii) a status of the incident record (e.g., open, unassigned, in progress, closed), (iii) a description of the issue (e.g., a manually, semi-autonomously, or fully-autonomously generated textual summary of the problem the user has encountered), (iv) a date/time when the incident record is created, (v) dates/times when the status of the issue or any other information of the incident record is changed, (vi) a current owner of the incident record (e.g., the agent or group of agents assigned to resolve the issue), (vii) a priority level for the incident record (e.g., low, medium, or high), (viii) information indicating any efforts that have been made toward resolving the issue (e.g., dates/times such efforts were started and/or completed, and a description of such efforts), (ix) an incident number, (x) a date/time by which resolution of the issue is due or requested by the user to be completed, and/or other information. This information may be textual, and/or may include images, sounds, videos, etc.

Once the operations of the state 602 have been completed, the incident record may transition to a state 604. In the state 604, also called a “first response” state, the operations may involve assigning the incident record to the agent. The incident record may be manually or automatically assigned to the agent, so that the agent is effectively tasked with resolving the reported issue. Through the workflow management application, the agent may access and review the incident record, and may begin providing assistance to the user in an attempt to resolve the issue. For instance, the agent may communicate with the user, perhaps through a communication interface provided by the application.

Once the operations of the state 604 have been completed, the incident record may transition to a state 606. In the state 606, also called a “categorization and comments” state, the operations may involve categorizing the incident. The assigned agent, relying on his or her expertise and/or information resources, may review the incident record and categorize the incident. Alternatively, categorizing the incident may be performed automatically by the workflow management application. Within examples, the incident record may be categorized by type (e.g., software, hardware, or service requests), priority, or service-level agreement, among other example categories.

Additionally, the activities of the state 606 may involve providing comments on the reported incident. Like the categorization operation, this operation may be assigned to the agent or may be performed automatically by the workflow management software. For example, the comments may include a diagnosis that specifies the full symptoms of incident.

Once the operations of the state 606 have been completed, the incident record may transition to either state 608 or state 610. In particular, the state to which the incident may transition may depend on the outcome of the state 606. For example, if the outcome of the state 606 indicates that the agent has the knowledge and expertise to resolve the incident, then the incident may transition to state 610, also called a “solution proposal” state.

On the other hand, if the agent does not have the expertise to propose a solution, the agent may need support from other agents and/or organizational units. In this scenario, the incident may transition to state 608 in which the incident record is transferred to another agent and/or another organizational unit. In this state, also called “incident transfer,” in addition to the incident record transferring to the other agent, the agent originally assigned to the incident may communicate with the newly assigned agent, perhaps by way of a communication interface provided by the workflow management software. Once the new agent reviews the incident record, the incident may transition to state 610.

Whether the incident transitions from state 606 or state 608, the operations of state 610 may involve the agent assigned to the task proposing a solution. To assist the agent in finding the solution, the workflow management software may provide the agent with resources that are related to the incident. These resources may include articles, videos, or other media related to the incident. The resources may also include historical data indicative of previous solutions to similar incidents.

The workflow management software may provide the agent with a graphical user interface through which the agent may enter a proposed solution. Once a solution for the incident is proposed, the incident may transition to a state 612 titled “closure.” In this state, the system may provide the agent with an indication that the incident has been resolved. Additionally, in this state, the system may provide the user with the proposed solution to the incident. Further, the registry entry of the incident in the system may be closed by providing the end-status of the incident.

FIG. 6B illustrates a multi-state workflow 620 for resolving a problem record, in accordance with an example embodiment. A problem record may describe or otherwise relate to an issue commonly specified in a number of incident records. On this point, the database device of the remote network management platform 320 may contain link(s) between a given problem record and incident record(s) to which the given problem record is related according to the common issue. As such, a given problem record could assist with management of an issue commonly reported in several incident records.

When a new problem record is created, the problem record may be assigned to and/or transition to a state 622 for newly-opened records, also called a “New” state. The problem record may then be assigned to and/or transition to a state 624. This state, titled “assess,” may include operations that involve assessing the problem record. In particular, the operations may include categorizing the problem record, confirming whether the issue described in the problem record is indeed an issue that needs to be resolved, and/or determining whether the problem record should be closed (e.g., due to being a duplicate or for other reasons). Within examples, the operations of the state 624 may be assigned to the agent to perform and/or may be automatically performed by the workflow management software.

The problem record may then be assigned to and/or transition to a state 626. This state, titled “root cause analysis,” may include operations for performing root cause analysis. For instance, the agent may attempt to identify the underlying cause of the problem in order to permanently or sufficiently fix it. The problem record may then be assigned to and/or transition to a state 628. This state, titled “fix in progress,” may involve operations for fixing the issue. For instance, the agent may apply a resolution for the problem (e.g., one or more fixes for the issues identified during root cause analysis).

The problem record may then be assigned to and/or transition to a state 630. This state, titled “resolved,” may include operations for determining that the problem has been resolved. For example, the operations performed in this state may indicate that one or more fixes were applied to resolve the problem, and that the problem has been resolved.

The problem record may be assigned to and/or transition to a state 632. This state, titled “closed,” may include operations for closing the problem record. For example, the operations may indicate an end to management of the problem record, such as due to the problem record being a duplicate, due to the problem being resolved, and/or due to acceptance of the risk posed by the problem, among other possible reasons.

Moreover, FIG. 6B illustrates other transitions between the states of the multi-state workflow 620. For example, the problem record could transition from the state 624 for records undergoing assessment to the state 632 for closed records. Such a transition may be accompanied with storing, in a database, of a resolution code indicating that the problem record is a duplicate of another record and/or that the problem record is cancelled. In yet another example, the problem record could transition from the state 626 for records undergoing root cause analysis to the state 632 for closed records. Such a transition may be accompanied with storing, in a database, of a resolution code indicating that the problem record is a duplicate of another record, that the problem record is cancelled, and/or acceptance of a risk posed by the issue associated with the problem record. In yet another example, the problem record could transition from the state 628 for records with a fix in progress to the state 632 for closed records. Such a transition may be accompanied with storing, in a database, of a resolution code indicating acceptance of a risk posed by the issue associated with the problem record. In yet another example, the problem record could transition from the state 630 for resolved records back to the state 626 for records undergoing root cause analysis. In yet another example, the problem record could transition from the state 632 for closed records back to the state 626 for records undergoing root cause analysis and/or back to the state 630 for resolved records. Note that not all transitions in FIG. 6B are explicitly described, and that other examples are also possible.

The example workflows depicted in FIGS. 6A and 6B are workflows that may primarily be used by IT service management (ITSM). However, the enterprise may include workflow management software associated with workflows for other task-based processes including, but not limited to, customer service management (CSM), and human resources (HR).

### VI. Providing Real-Time Feedback to Agents

In line with the discussion above, when an agent employs a workflow management application to perform a work item (e.g., resolve an incident), he or she may not receive feedback on the performance of the work item for a long period of time, thereby rendering the feedback of limited use. Furthermore, in practice, when an agent encounters difficulty performing a work item, the agent does not receive contextual or timely assistance, which often leads to the work item being performed incorrectly or inadequately.

Disclosed herein are systems and methods for providing feedback to an agent, e.g., an agent of the managed network 300, that is performing a work item according to a workflow. In an embodiment, a computing system may allow for a reviewer or supervisor to define a feedback moment in which the reviewer (e.g., the administrator, another employee, or a virtual reviewer) may provide feedback to the agent. Subsequently, when the feedback moment occurs, the computing system may facilitate the reviewer providing feedback to the agent.

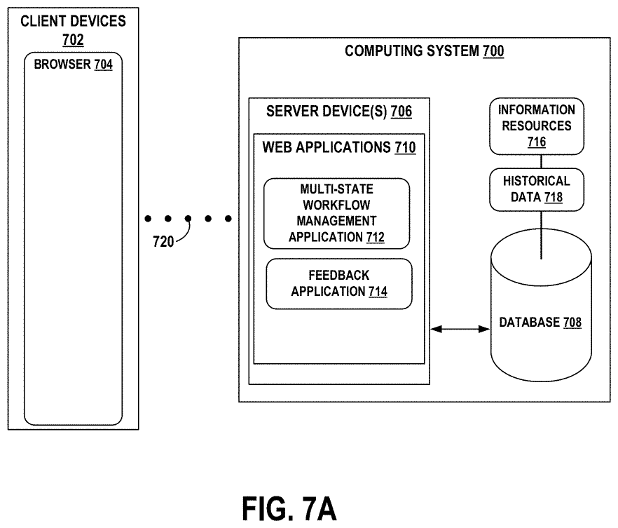

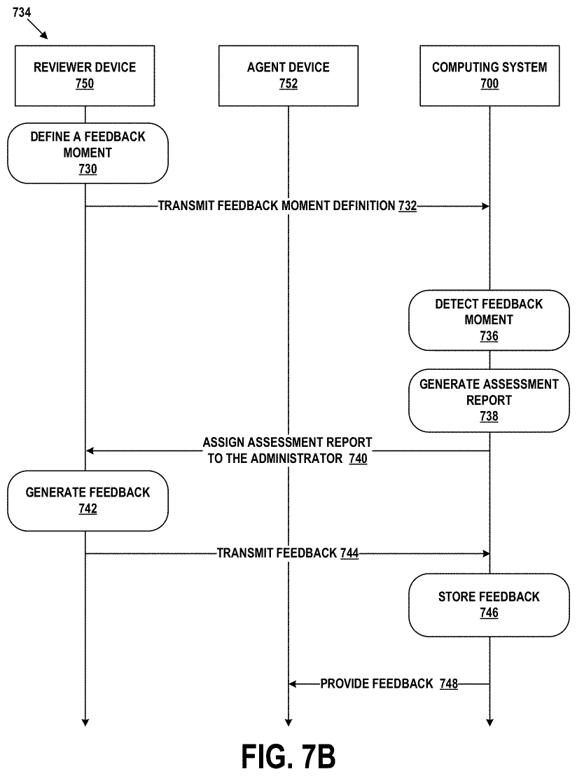

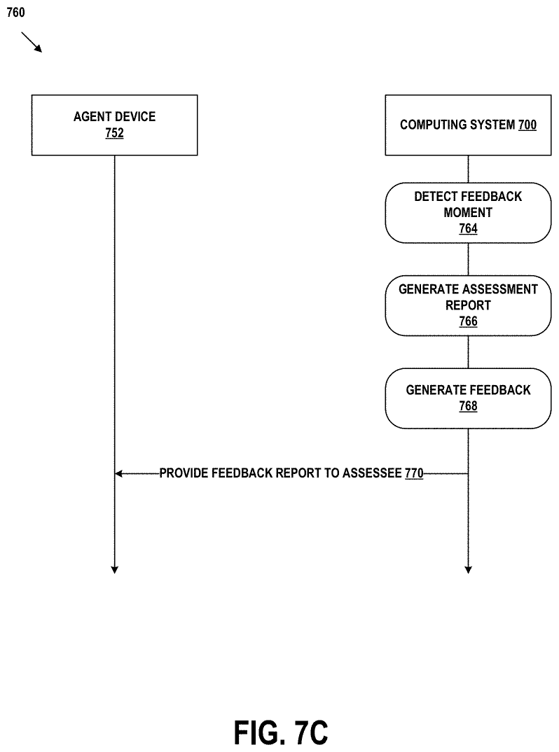

FIG. 7A illustrates features, components, and/or operations of a computing system 700 and a managed network's client devices 702, according to an example embodiment. Within examples, the computing system 700 may be disposed within a computation instance 322 of remote management platform 320. Although FIG. 7A illustrates a specific arrangement, embodiments disclosed herein may be carried out in the context of similar and/or other arrangement(s) as well without departing from the scope of the present disclosure.

The client devices 702 may be one of the client devices 302 on the managed network 300, for example. Generally, the client devices 702 may engage in communication with computing system 700, such as via wired and/or wireless communication link(s) (represented in FIG. 7A by a link 720). Moreover, as shown, the client devices 702 may each be configured to operate a web browser 704, which is an application that may retrieve, present, and/or navigate through information on the World Wide Web and/or on private websites.

As described below, the browser 704 may be used to access applications hosted by the computing system 700. In an implementation, different client devices 702 may be authorized to access different applications. For example, a reviewer of the managed network may have access to different applications than an agent of the managed network. Additionally and/or alternatively, different client devices 702 may be authorized to access different features of the same application. For example, the reviewer may be authorized to access different features of an application than the agent.

Additionally, the computing system 700 may include server device(s) 706. The server device(s) 706 may contain or may otherwise have access to program instructions executable by processor(s), so as to cause the computing system 700 to carry out various processes described herein. On this point, the server device(s) 706 may include server device(s) disposed within a computational instance of a remote network management platform, such as computational instance 322 of remote network management platform 320, and/or may include server device(s) disposed within a managed network (e.g., managed network 300). Thus, the various embodiments described herein could be carried out by just one server device and/or could be distributed among two or more server devices in any feasible manner. As such, the computing system 700 could include features and/or components of a managed network and/or of a remote network management platform that supports remote management of the managed network.

The computing system 700 may also include a database 708. This database 708 could be a CMDB of a computational instance, such as CMDB 500 for example. Additionally or alternatively, database 708 may be a database that is different from a CMDB. Moreover, the database 708 may contain information resources 716. The information resources 716 may include information that describes how to implement workflows within the managed network. The information resources 716 could be downloaded from the web, generated by users of the managed network 300, and/or uploaded by individuals associated with the remote network management platform 320, among other possibilities.

Within examples, the information resources 716 may include training courses on implementing workflows and/or best practices for performing operations of workflows. The information resources 716 may also include one or more knowledge base articles that include information related to the workflows, information related to best practices when performing operations of the workflows, and information describing how to use certain software and/or hardware. In yet another example, the information resources 716 may include media content related to the workflows and/or best practices when performing operations of the workflows. The media content may be audio and/or video content.

Moreover, the database 708 may contain historical data 718. The historical data 718 may include records of previously performed work items related to the managed network. The records may include information about the work items and metrics that describe the performance of the work items. For example, the historical data 718 may include a previously resolved incident record, and may include metrics of resolving the incident record (e.g., the agent(s) that resolved the incident, resolution time, accuracy of resolution, customer satisfaction with the resolution, etc.).

As shown in FIG. 7A, the server device(s) 706 may include web applications 710. The server device(s) 706 may be configured to execute the web applications 710, perhaps when the web applications are accessed by client devices 702. As shown in FIG. 7A, the web applications 710 may include a multi-state workflow management application 712. As described above, a workflow management application may be employed by an agent to perform a work item in accordance with a multi-state workflow. Additionally and/or alternatively, the web applications 710 may include a feedback application 714. The feedback application 714 may be employed by the reviewer. Within examples, the reviewer may use the feedback application 714 to (i) define feedback moments, (ii) review agents' performances of operations, and (iii) provide the agents with feedback.

In line with the discussion above, feedback moments may be scenarios in which a reviewer may provide feedback to an agent. Such scenarios may be scenarios where the agent may need feedback. In an example, a feedback moment may be a scenario where the agent may need further instructions when performing operations. This feedback moment may occur when a work item being performed by the agent spends greater than a threshold amount of time in a particular state. In another example, a feedback moment may be a scenario where the agent may need additional training. This feedback moment may occur when a state is reopened, when a work item is reassigned to a different agent, or when the agent does not complete the operations of a state before transitioning the work item to the next state. In yet another example, a feedback moment may be in a scenario where the reviewer may want to review certain operations. Such a feedback moment may occur when those operations are performed. Other examples of feedback moments include: when a new agent performs operations, when a new workflow is added to the managed network, among other examples.

In an embodiment, the reviewer may define a feedback moment by specifying one or more parameters and/or conditions that describe the scenario in which the feedback moment may occur. A first parameter may be an identifier of a multi-step workflow. Generally, a reviewer may be responsible for overseeing a group of agents or a type of multi-step workflow (e.g., IT workflow, HR workflow, etc.). Accordingly, the reviewer may select a multi-step workflow that is used by the group of agents or a multi-step workflow that is of the type that the reviewer is responsible for overseeing.

A second parameter may specify a target state of the selected multi-state workflow. The target state may include operations performed by the agent. Specifying a target state indicates that a feedback moment may occur in connection with the operations of the target state.

A third parameter may specify one or more state variables of the target state that the reviewer would like to review when a feedback moment occurs. As explained above, state variables may include data variables (e.g., proposed resolution) that describe operations of the state or the results thereof, and may include performance variables (e.g., length of performance) that are related to performance of operations of the state. The reviewer may review the state variables to evaluate the performance of the operations of the target state. For example, the performance may be evaluated by comparing values of the state variables to other data. As explained herein, the values of the state variables may be compared to (i) historical values of the state variables and/or (ii) pre-determined threshold values for the state variables. In some examples, the pre-determined threshold values may be defined by a reviewer, and therefore may be considered a fourth parameter that defines the feedback moment.

The reviewer may also specify one or more conditions that define the feedback moment. A first condition may specify a threshold priority level of the work item being performed in connection with the workflow. Such a condition may limit the feedback moment to occur only when work items of at least the threshold priority level are being performed. A second condition may specify the agents performing the work item in order for the feedback moment to occur. For instance, the feedback moment may occur only if a specified agent is performing the work item. Other conditions may exist.

Once a feedback moment is defined, the feedback application 714 may monitor the work items being performed in connection with workflows in order to detect the feedback moment. If a feedback moment is detected, the feedback application 714 may flag for review the operations that have been performed or that are being performed in connection with the feedback moment.

In an embodiment, responsive to detecting the feedback moment, the feedback application 714 may provide a reviewer with an assessment report. The assessment report may include information from the work item, information about the flagged operations, a profile of the agent performing the work item, tracked metrics of the work item (e.g., time and/date of performance), and values of state variables of the target state of the feedback moment, among other information. The reviewer may evaluate the assessment report in order to provide the agent with feedback.

FIG. 7B illustrates a message diagram 734 of providing feedback to an agent at an agent device, according to an example embodiment. The embodiments of the flowchart may be performed by a computing system 700, an agent device 752, and a reviewer device 750. The agent device 752 and the reviewer device 750 may be client devices 702, for example. Within examples, the embodiments may be performed so that a reviewer may provide feedback to an agent that is performing an assigned work item.

As shown by block 730 of FIG. 7B, a reviewer, by way of the reviewer device 750, may define a feedback moment. In particular, the reviewer may specify one or more parameters and/or conditions that define the feedback moment. For example, the parameters may specify that the multi-state workflow is an incident management workflow (e.g., workflow 600 depicted in FIG. 6A), that a target state is a solution proposal state, and that a state variable for review is a proposed solution. Furthermore, a condition may be that a priority level of an incident that is being resolved is at least moderate (e.g., on a priority level scale of: Critical, High, Moderate, Low, Planning). Accordingly, this feedback moment may occur when an agent provides a proposed resolution when an incident report is in a solution proposal state, and where the incident report has at least a moderate priority level.

As shown by arrow 732, the reviewer device 750 may transmit the feedback moment definition to the computing system 700. Upon receiving the definition, the computing system 700 may continuously or periodically, perhaps by way of feedback application 714, monitor the performance of work items in order to detect if the feedback moment occurs.

As shown by block 736, the computing system 700 may detect a feedback moment. In particular, the computing system 700 may detect that a scenario that satisfies the defined parameters and/or conditions has occurred. Continuing with the example above, the computing system 700 may detect a feedback moment by detecting that an incident that has a priority level “High” is being resolved. Additionally, the computing system may determine that Agent Joe Smith is addressing the incident according to an incident management workflow. Further, the computing system 700 may detect that the incident has transitioned into a solution proposal state. Yet further, the computing system 700 may detect that the agent has provided a proposed solution.

As shown by block 738, responsive to detecting the feedback moment, the computing system 700 may generate an assessment report. The assessment report may include information from the work item, a profile of the agent performing the work item, and values of state variables of the target state of the feedback moment, among other information. The profile of the agent may include the agent's areas of expertise, training and/or certifications received by the agent, historical data of the agent's work performance (e.g., resolution time, service-level agreement (SLA) compliance, number of work item/operations reassignments, number of work item/operations reopenings), previous feedback received by the agent, among other examples.

Continuing with the example above, the computing system 700 may generate an assessment report that includes: a profile of Agent Joe Smith, the proposed solution provided by Agent Joe Smith, and one or more performance variables (e.g., length of time to perform the operations, date of performing the operations, informational resources utilized by the agent, etc.).

As shown by arrow 740, the computing system 700 may assign the assessment report to the reviewer who for the purposes of this example is a reviewer that is responsible for reviewing the assessment report. For instance, the reviewer may be responsible for overseeing the agent's work and providing feedback to the agent, or may be responsible for overseeing the multi-state workflow (specified by the feedback moment). Continuing with the example above, the assessment report may be assigned to a supervisor of Agent Joe Smith.

As shown by block 742, once the reviewer device 750 receives the assessment report, the reviewer device 750 may generate feedback for the agent. In order to generate contextual and useful feedback, the reviewer may review the assessment report to evaluate the agent's performance while considering the agent's profile.

In an embodiment, the feedback may include an evaluation of the agent's performance of the operations in the target state, perhaps using an evaluation system specific to the managed network. For example, the feedback may include one of the ratings: “Excellent,” “Good,” “Average,” and “Poor.” Additionally and/or alternatively, the feedback may include a category of follow-up needed for the agent. The follow-up categories may include: “Additional instruction needed,” “Training needed,” and “Lack of Due Diligence.” If the agent is facing difficulty completing assigned operations, then the category “Additional instruction needed” may be selected, if the agent incorrectly performed the assigned operations then the category “Training needed” may be selected, and if the agent inadequately performed the assigned operations then the category “Lack of due diligence” may be selected. Furthermore, if the feedback category is either “Additional instruction needed” or “Training needed” the feedback may include information that provides the agent with additional instruction and/or training. As explained above, such information may be stored in information resources 716. Accordingly, the feedback may include a link to the information resources 716.

Continuing with the example above, the Agent Joe Smith's reviewer may review the generated assessment report. In particular, the reviewer may determine that Agent Joe Smith did not provide a correct a proposed solution. In response to the determination, the reviewer, via the reviewer device 750, may provide feedback for the agent. The feedback may include an evaluation rating of “Poor” and follow-up category of “Training needed.” The feedback may also include links to training courses and other materials for the agent.

As shown by arrow 744, the reviewer device 750 may transmit the feedback to the computing system 700. Then, as shown by block 746, the computing system 700 may store the feedback, perhaps in a record associated with the work item. Then, as shown by the arrow 748, the computing system 700 may provide the feedback to the agent device 752.

FIG. 7C illustrates another flowchart 760 of providing feedback to an agent device, according to an example embodiment. Unlike the message diagram 734 of FIG. 7B, embodiments of the flowchart 760 may involve only a computing system 700 and the agent device 752. In this embodiment, the feedback moment may be defined by a reviewer (not illustrated in FIG. 7C).

As shown by block 764, the computing system 700 may detect a feedback moment, perhaps as described above in connection with FIG. 7B. As shown by block 766, responsive to detecting the feedback moment, the computing system 700 may generate an assessment report, perhaps as described above in connection with FIG. 7B.

As shown by block 768, the computing system 700 may then automatically generate feedback for the agent. Here, the computing system 700 is generating the feedback as opposed to a human reviewer. In an example, the computing system 700 may include modules and/or resources dedicated to a “virtual reviewer” that may review assessment reports and generate feedback based on the assessment reports.

In an embodiment, the virtual reviewer may evaluate the assessment report by comparing the information in the assessment report to standard values of the information. In an implementation, the standard values may be historical values for previously performed operations that are similar to or the same as the flagged operations. In some examples, the information in the assessment report may be compared to historical values of similar previously performed operations. In other examples, the information may be compared to historical values of similar previously performed operations performed by the agent and/or other agents. In another implementation, the standard values may be pre-defined threshold values. For example, the virtual reviewer may compare values of one or more state variables related to the target state to threshold values of the one or more state variables.

Within examples, comparing the information in the assessment report to the standard values may involve determining an extent of similarity between the information in the assessment report and the standard values. Based on the extent of similarity, the computing system 700 may determine an evaluation for the assessment report. For example, if the extent of similarity between the compared values does not meet a threshold extent of similarity, then the computing system 700 may determine that the agent did not perform the operations correctly. Conversely, if the extent of similarity between the compared values meets a threshold extent of similarity, then the computing system 700 may determine that the agent performed the operations correctly.

The computing system 700 may then generate the feedback based on the evaluation of the assessment report. The feedback may include an evaluation of the agent's performance of the operations in the target state. Additionally and/or alternatively, the feedback may include a category of follow-up needed for the agent. Additionally and/or alternatively, the feedback may include a link to the information resources 716. As shown by arrow 770, the computing system 700 may then provide the feedback to the agent device 752.

Also disclosed herein are graphical user interfaces (GUIs) that may be used to provide timely and/or contextual feedback to a user. In an example, the disclosed GUIs may be GUIs of the web applications 710 depicted in FIG. 7A.

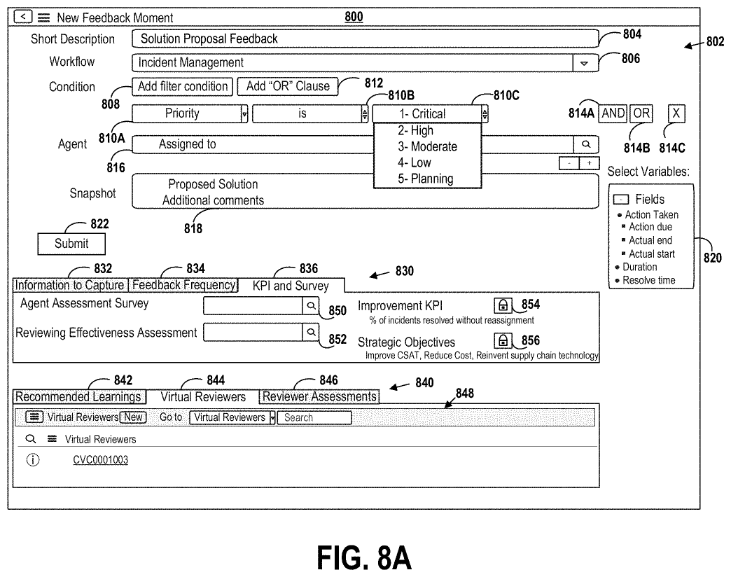

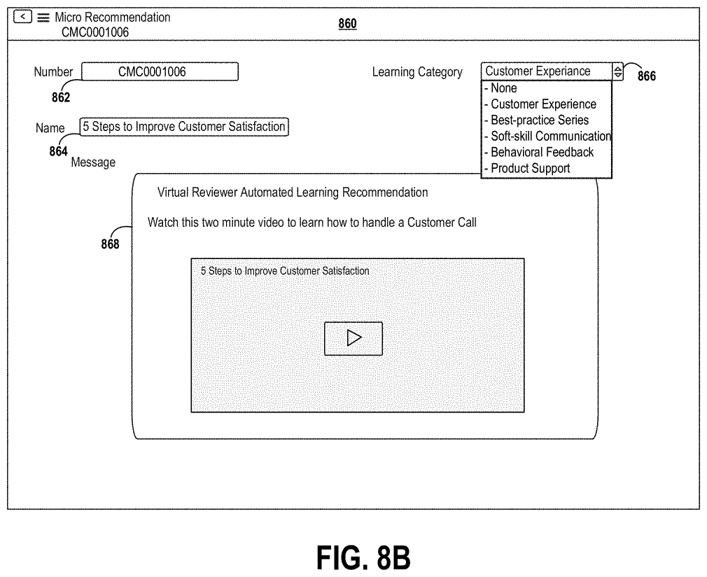

FIG. 8A illustrates a GUI 800 for creating a feedback moment, according to an example embodiment. In an implementation, the GUI 800 may be accessed by an administrator that has authorization to create feedback moments. To the access the GUI 800, the administrator may access an application (e.g., feedback application 714 depicted in FIG. 7A) that is responsible for defining the feedback moments.

As shown in FIG. 8A, the GUI 800 includes a section 802. Section 802 includes fields that display and/or enable entry of information that may define a feedback moment. In particular, section 802 includes a field 804 that may enable entry of a short description of the feedback moment. Additionally, the section 802 may include a field 806 that may enable selection of a workflow that includes a desired target state. The workflow may be selected by first clicking on a button near the field 806 to cause the GUI 800 to display a dropdown menu that includes a list of the workflows. Once a workflow is selected, the field 806 may be automatically populated with an identifier of the selected workflow, e.g., a name of the workflow.

Further, the section 802 may include a button 808 labelled “Add filter condition.” Clicking the button 808 may cause the GUI 800 to display one or more fields 810A, 810B, and 810C. These fields may enable selection of one or more conditions for the feedback moment. For example, a dropdown menu of the field 810A may be used to select that a condition may be based on a priority of a work item that is being performed according to the selected workflow. Selecting a particular value from the dropdown menu of the field 810A may auto-populate the drop-down menu 810C with certain values. For example, if “Priority” category is selected in field 810A, then a list of priority levels (e.g., “1-Critical”, “2-High”, “3-Moderate”, “4-Low”, “5-Planning”) may be displayed in a drop-down menu 810C. And the field 810B may be used to select a relationship between the selected condition in field 810A and the selected value in 810C.

The section 802 may also include a button 812 labelled “Add ‘OR’ Clause.” Selecting that button may add an “OR” clause to the condition. Additionally, the section 802 may include buttons 814A, 814B, 814C. The GUI 800 may display these buttons next to each condition that is added to the feedback moment. Specifically, selecting button 814A may add an “AND” statement to the condition, selecting button 814B may add an “OR” clause to the condition, and selecting button 814C may delete the condition.

Additionally, the section 802 may include a field 816 that may enable selection of an agent. Selecting an agent may limit the applicability of the feedback moment to that agent. If the field 816 is kept blank (i.e., an agent is not selected), then the feedback moment is not limited to certain agents and may be applicable to any agent that is performing operations according to the defined parameters and/or conditions.

The section 802 may also include a field 818 that may enable selection and/or entry of parameters for the feedback moment. For instance, the parameters may include state variables to be reviewed or evaluated when the feedback moment occurs. In an implementation, the administrator may manually enter one or more parameters into the field 818. In another implementation, the administrator may use a menu 820 that includes a list of variables to add to the field 818 as parameters. The menu may include any fields or variables that are used in or are related to multi-state workflows of the managed network. The menu 820 illustrates some example variables that may be added as parameters of the feedback moment. The variables include: an action due date, actual end of an action, actual start of an action, a duration, and a resolve time.

The section 802 may also include a button 822. Clicking the button 822 may submit the feedback moment as a new feedback moment. Once the feedback moment is submitted, the operations of the managed network may be monitored in order to detect the feedback moment.

As also illustrated in FIG. 8A, the GUI 800 may include section 830 that includes three tabs 832, 834, 836, labelled “Information to Capture,” “Feedback Frequency,” and “KPI and Survey,” respectively. The tab 832 may include one or more fields (not illustrated) for selecting additional information to include in an assessment report generated when the feedback moment is detected. These fields may assist the reviewer with providing feedback to an agent. The tab 834 may include one or more fields (not illustrated) for defining a feedback frequency. The feedback frequency may be defined as a period of time (e.g., hours, days, months, etc.) over which the system may detect the feedback moment. Additionally and/or alternatively, the feedback frequency may be defined as a percentage of feedback opportunities that may be flagged for review. For instance, a greater percentage of feedback moments associated with newly implemented processes may be flagged for review than feedback moments associated with older processes. The feedback frequency may be adjusted at any time.

The tab 836 may include fields 850, 852, 854, and 856. Field 850, labelled “Agent Assessment Survey,” may be used to select an assessment survey to be filled by the reviewer when providing feedback to the agent. The assessment survey may include one or more pre-determined questions and/or fields for providing an assessment of the agent's performance. The assessment survey may be provided to the reviewer along with an assessment report that is generated in connection with the occurrence of a feedback moment. Field 852, labelled “Reviewing Effectiveness Assessment,” may be used to select an assessment survey to be filled by the agent once the agent receives feedback from the reviewer. The assessment survey may include one or more pre-determined questions and/or fields for providing an assessment of the reviewer's review and/or feedback.

Field 854, labelled “Improvement KPI,” may be used to select a key performance indicator (KPI) to be measured in connection with the feedback moment. For example, if a purpose of the feedback moment is to improve the skill level of agents over time, then a KPI for measuring the skill of the agents may be linked to the feedback moment. By linking a KPI to a feedback moment, a reviewer or other administrator of the enterprise may evaluate the efficacy of the feedback moment. The KPIs that are linked to the feedback moment may be KPIs that are already being measured by the enterprise or may be KPIs that are measured for the feedback moment. Example KPIs that may be linked to a feedback moment include, but are not limited to, a percentage of work items that are resolved without reassignment, the number of information resources available, the quality of information resources available, and average resolution time of work items.

Field 856, labelled “Strategic Objectives,” may be used to link one or more strategic objectives to the feedback moment. The strategic objectives may be objectives or goals of the enterprise. By linking a strategic objective to a feedback moment, a reviewer or other administrator of the enterprise may evaluate how the feedback moment is contributing to the strategic objective. Example strategic objectives that may be linked to a feedback moment include, but are not limited to, improving customer satisfaction (CSAT), reducing cost, and reinventing supply chain technology.

As also illustrated in FIG. 8A, the GUI 800 may include section 840 that includes three tabs 842, 844, 846, labelled “Recommended Learnings,” “Virtual Reviewers,” and “Reviewer Assessments,” respectively. The tab 842 may include one or more fields (not illustrated) for defining a recommended learning path associated with the feedback moment. The recommended learning path may include one or more resources that may be automatically assigned to an agent that performs an action that triggers the feedback moment. In an example, the agent may review the materials to facilitate discussion between the agent and a reviewer when the reviewer provides the agent with feedback. In another example, a virtual reviewer may provide the recommended learning path to the agent.

The tab 846 may include one or more fields (not illustrated) for defining reviewer assessments to be provided to the agent when the agent receives feedback from the reviewer in connection with the feedback movement. For example, the assessments may include a questionnaire that allows the agent to assess the quality of feedback provided to the agent. Other example assessments, such as a comments field, are contemplated herein.

The tab 844 may include a table 848 that lists virtual reviewers that are linked to the feedback moment. The virtual reviewer may receive an assessment report generated in connection with the feedback moment. The linked virtual reviewer may provide feedback in the form of a recommended learning path.

FIG. 8B illustrates a GUI 860 for defining a recommended learning path, according to an example embodiment. As shown, the GUI 860 includes fields 862 and 864 that are labelled “Number” and “Name,” respectively. The fields 862 and 864 may be used to define identifiers for the recommended learning path. The field 862 may be automatically populated with an auto-generated alphanumerical identifier (e.g., “CMC0001006”). And the field 864 may be populated by way of an input indicative of a desired name (e.g., “5 Steps to Improve Customer Satisfaction”). Additionally, the GUI 860 may include a field 866, labelled “Learning Category,” that defines a category for the recommended learning path. Clicking a button near the field 866 opens a dropdown menu listing pre-defined categories. As shown in FIG. 8B, the pre-defined categories may include “Customer Experience,” “Best-practice Series,” “Soft-skill Communication,” “Behavioral Feedback,” and “Product Support.”

The GUI 860 may also include a field 868, labelled “Message,” that defines a message that is provided to an agent when assigned the recommended learning path. The field 868 may include information resources of the recommended learning path. The field 868 may include a link to the information resources and/or may embed the information resources. For example, as shown in FIG. 8B, a video resource may be embedded in the field 868. Additionally, the field 868 may include messages provided with the recommended learning path. The messages may include instructions and/or feedback for the agent.

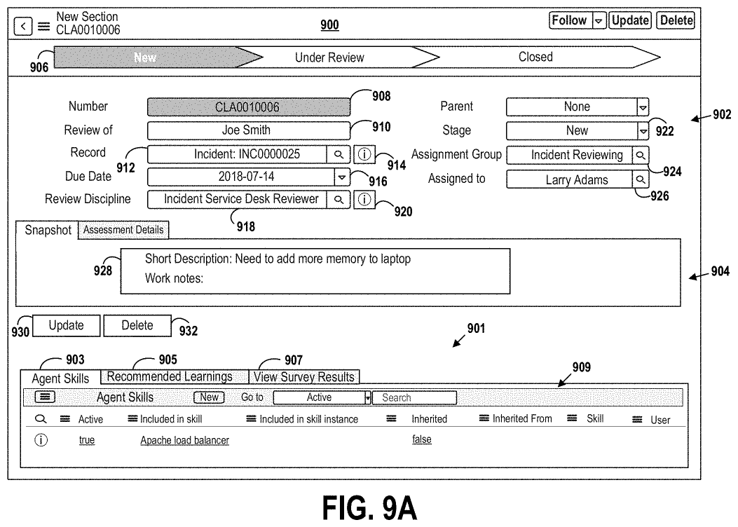

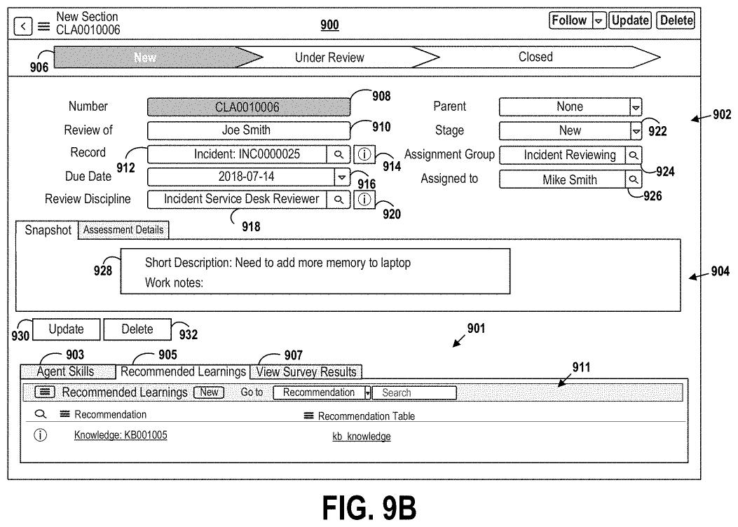

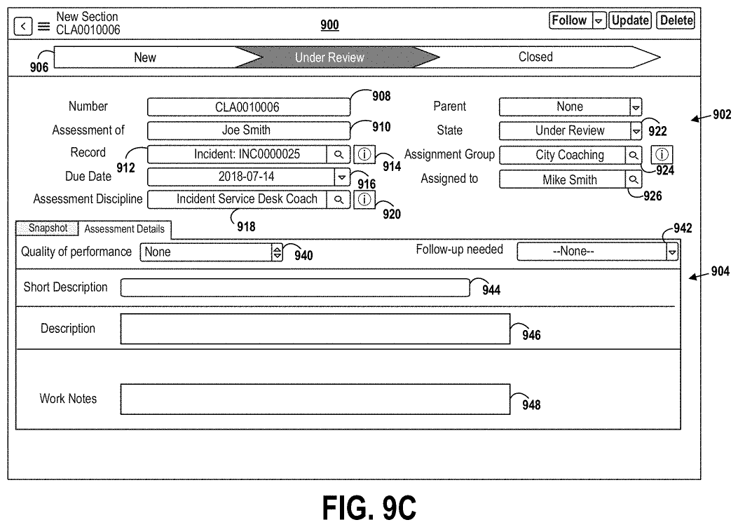

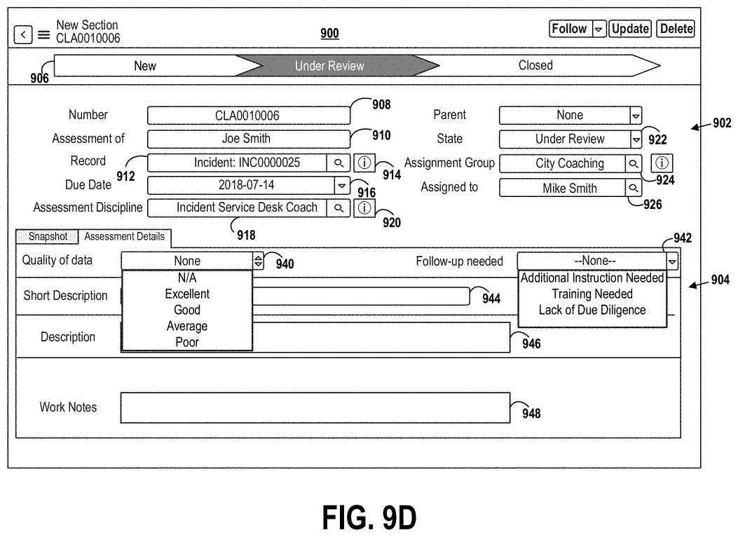

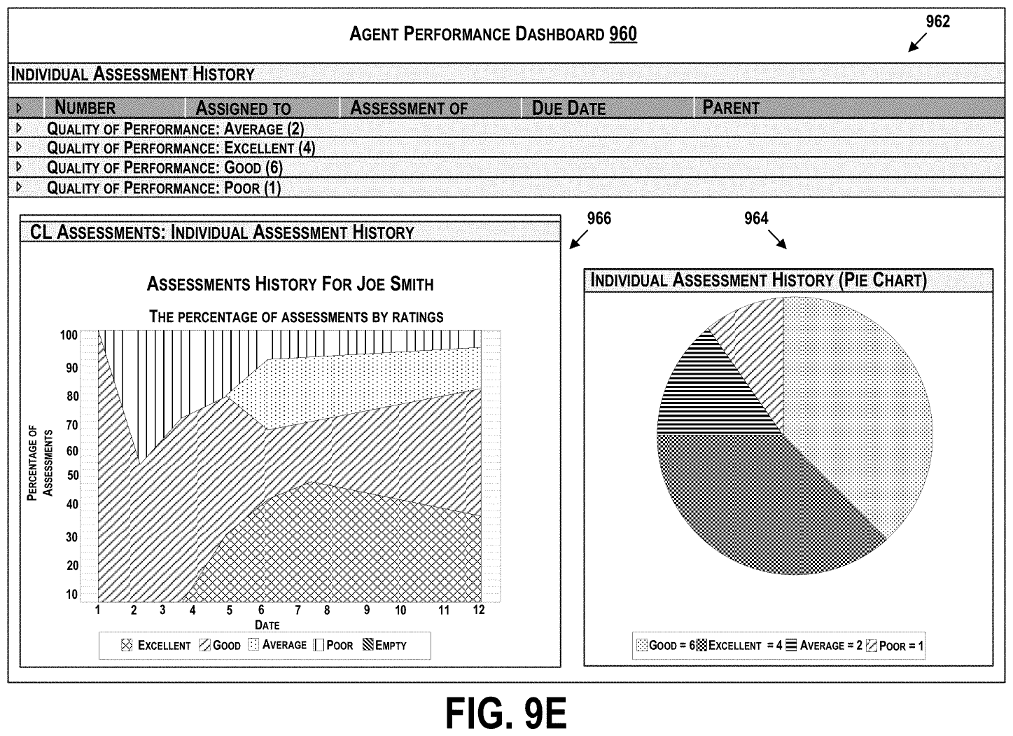

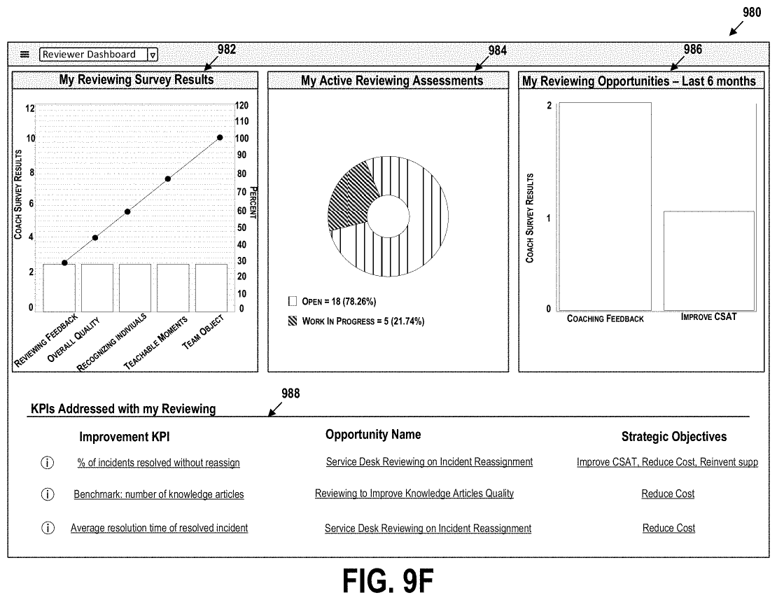

Next, FIGS. 9A-9D provide an illustrative example of GUI panes that correspond to various stages of a reviewer reviewing and providing feedback on an assessment report, according to an example embodiment. In an implementation, the assessment report may be assigned to one of three stages at any given time. The first stage is a “New” stage in which the reviewer has not initiated review of the assessment report. The second stage is “Under Review” in which the reviewer is reviewing the assessment report and providing feedback. The third stage is “Closed” in which the reviewer indicates that the review of the assessment report has been completed. In an embodiment, in response to transitioning to a “Closed” stage, the feedback application may send the feedback to the agent.

FIG. 9A shows a GUI pane 900 that corresponds to a first stage of reviewing an assessment report. The GUI pane 900 may include a section 902, a section 904, a section 901, and a graphic 906, among other features.

Section 902 includes fields that display and/or enable entry of information for an assessment report. For example, the section 902 includes a field 908 showing a unique identifier of the assessment record (e.g., “CLA0010006”), which may be automatically assigned and/or manually entered. In another example, the section 902 includes a field 910 showing an agent associated with the assessment record (e.g., Joe Smith). In yet another example, the section 902 includes a field 912 showing an incident associated with the assessment record. For instance, the incident may be identified by an identifier (e.g., “Incident: INC0000025”). Next to the field 912, the section 902 may include a button 914. Clicking the button 914 may display more information about the incident.

Additionally, the section 902 may include a field 916 that shows a due date by which to complete review of the assessment record. In some examples, the due date may be auto-populated with a specific date, perhaps a pre-defined number of days from the day that the assessment report was received. The section 902 may also include a field 918 that shows a review discipline for the assessment report. The review discipline may indicate a desired specialty of the reviewer. For instance, the review discipline may be an incident service desk reviewer. Additionally, the section 902 may include a button 920 near the field 918. Clicking the button 920 may provide more information about the review discipline.

Further, the section 902 may include a field 922 that shows a review stage of the assessment report. A reviewer may change the stage by clicking a button near the field 922 that opens a dropdown menu listing the three stages of review. The reviewer may change the stage by selecting one of the stages from the dropdown menu. Yet further, the section 902 may include a field 924 that shows the assignment group (e.g., “Incident Reviewing”) to which the assessment report is assigned. Yet further, the section 902 may include a field 926 that shows the reviewer to whom the assessment report is assigned.

Section 904 includes two tabs: a “Snapshot” tab and an “Assessment Details” tab. As shown in FIG. 9A, the snapshot tab may include a snapshot field 928. The snapshot field 928 may include information from the assessment report indicative of an agent's performance. For instance, the snapshot field 928 may include one or more state variable values that were provided by the agent. In the example illustrated in FIG. 9A, the snapshot field 928 may include a short description of a resolution provided by the agent.

Additionally, the GUI 900 may include buttons 930 and 932, which may allow a reviewer to update the assessment report or delete the assessment report.

Further, the graphic 906 identifies the various stages of reviewing an assessment record, and visually points out the stage corresponding to GUI pane 900. In particular, the graphic 906 includes a list of stage identifiers representative of the various stages. For example, the graphic 906 shows a “New” identifier, followed by an “Under Review” identifier, followed by a “Closed” identifier. Moreover, the graphic 906 includes a visual depiction indicating the state to which the problem record is assigned. For example, the “New” identifier of the graphic 906 is highlighted to indicate that the assigned reviewer has not begun review of the assessment report.

In order to transition to the “Under Review” stage, the reviewer may use the field 922 to select the desired stage. In particular, when the selection is made, the computing system may provide, to the reviewer device for display, a GUI pane corresponding to the “Under Review” stage.

Section 901 includes three tabs 903, 905, and 907, labelled “Agent Skills,” “Recommended Learnings,” and “Survey Results.” Tab 903 may include a table 909 that lists the skills of the agent associated with the assessment report. The reviewer may use the table 909 to review the skills of the agent (e.g., Agent Joe Smith) in order to generate feedback for the agent.

FIG. 9B illustrates GUI 900 with tab 905 opened. Tab 905 may include a table 911 that lists the recommended learning paths linked to the feedback moment associated with the assessment report. In some examples, a recommended learning path may have already been assigned to and performed by the agent. In such examples, the reviewer may open a record of the recommended learning path in order to review the agent's performance of the recommended learning path. In other examples, a recommended learning path may not yet be assigned to the agent. In such examples, the reviewer may review the recommended learning path before assigning the recommended learning path to the agent. The reviewer may also make changes to the recommended learning path before assigning the recommended learning path.

FIG. 9C shows an updated GUI pane 900 that corresponds to the “Under Review” stage. FIG. 9C also illustrates the “Assessment Details” tab of section 904. The “Assessment Details” tab may include fields 944, 946, and 948 labelled “Short Description,” “Description,” and “Work Notes,” respectively. In an example, these fields may be populated from information from the incident.

Additionally, the section 904 may include fields 940 and 942 labelled “Quality of performance” and “Follow-up needed,” respectively. These fields may be used to evaluate and provide feedback on the assessment report. For example, field 940 may enable selection of a level of quality of the agent's performance. Field 942 may enable selection of a recommended corrective measure for the agent.

FIG. 9D illustrates the GUI 900 of FIG. 9C with dropdown menus of fields 940 and 942 shown by the GUI 900. As shown in FIG. 9D, the field 940 may enable selection from one of the quality levels that include: “Excellent,” “Good,” “Average,” and “Poor.” In examples where the agent has not completed the assigned operations, “N/A” may be selected. As also shown in FIG. 9D, the field 942 may enable selection of one or more of the corrective measures: “Additional Instruction Needed,” “Training Needed,” and “Lack of Due Diligence.” The corrective measure of “Additional Instruction Needed” may provide the agent with further instructions on how to perform the operations. For example, this corrective measure may be provided to agents that may be facing difficulty in completing assigned operations. The corrective measure of “Training Needed” may provide the agent with additional training, perhaps by way of an in-person or simulated training course. For example, this corrective measure may be provided to agents that may have inaccurately or inadequately performed assigned operations. The corrective measure of “Lack of Due Diligence” may provide the agent with a reminder and warning as a result of their lack of due diligence. For example, this corrective measure may be provided to agents that, although having the correct training (as determined from a profile of the user), did not perform the operations correctly, perhaps due to a lack of due diligence.

FIG. 9E illustrates an agent performance dashboard 960, according to an example embodiment. As described herein, the term “dashboard” may refer to a graphical user interface component that contains one or more tabs. In some embodiments, a dashboard may be equivalent to or contained within a GUI window.

Specifically, the agent performance dashboard 960 may include one or more representations of feedback (e.g., assessments) received by an agent. In an example, the agent performance dashboard 960 may include sections 962, 964, and 966. As shown in FIG. 9D, section 962 may include a table representation of an agent's assessment history. In particular, the assessments received by the agent may be arranged in rows of the table. In some examples, the assessments may be grouped together into rows based on a quality of performance rating received in the assessment. For example, assessments with an average quality of performance may be grouped together. The row may indicate the quality of performance rating and a number of assessments that have that rating. This view of the table may be a contracted view of the table. The table may also include one or more columns, where each column includes a parameter of the assessment. For instance, the table in section 962 may include the columns: “Number,” “Assigned To,” “Assessment Of,” “Due Date,” and “Parent.”

As also shown in FIG. 9E, section 964 may include a pie chart representation of an agent's assessment history. For example, the pie chart may represent for each of the quality ratings the number of assessments that received that rating. Section 964 may also include a key for the pie chart.

As also shown in FIG. 9E, section 964 may include a stacked area chart representation of an agent's assessment history. For example, the stacked area chart may represent the percentage of assessments by the quality of performance ratings. In this chart, the y-axis may represent a percentage of the assessments, and the x-axis may be the relative date of performing the operations on which the agent has received the assessment.

The agent performance dashboard 960 may also include other representations of other performance indicators, such as a percent of high priority incidents resolved, the average time to resolve a high priority incident, the average time to resolve an incident, the percent of incidents resolved on first assignment, the percentage of incidents that were reopened, the percent of incidents resolved that fall within a service-level agreement (SLA), the percent of high priority problems, the average time to close a problem, the percentage of incidents resolved by a problem, the percentage of emergency change types, the average time to close a change type, the percentage of failed changes, the average time to fulfill a request, the percentage of closed requests that breached a service-level agreement, the number of knowledge base views for the agent, the percentage of incidents resolved by a knowledge base article, and/or an average overall customer satisfaction score. Furthermore, each of these metrics may be associated with a target state and values of these parameters may be considered when determining whether performances are compliant with the relevant standard.

FIG. 9F illustrates a reviewer performance dashboard 980, according to an example embodiment. The dashboard 980 may include sections 982, 984, 986, and 988. Section 982, titled “My Reviewing Survey Results,” includes a graphical representation of results of surveys provided to agents that have received feedback from the reviewer. For example, the graphical representation may depict a percentage that represents the reviewer's performance in each of one or more feedback categories (e.g., overall quality, recognizing individuals, etc.). Section 984, titled “My Active Reviewing Assessments,” may include a graphical representation of a breakdown of the statuses (e.g., open, closed, currently performing, etc.) of assessment records that are assigned to the reviewer for review. Section 986, titled “My Reviewing Opportunities—Last 6 months,” may include a graphical representation of various KPIs that are being measured in connection with the feedback that is provided by the reviewer. The KPIs may be measured over any period of time. This graphical representation may allow the reviewer to easily and quickly determine how the reviewer's feedback is improving the KPIs. The reviewer may also use the graphical representation to determine adjustments to be made to the reviewer's feedback. Section 988 includes a table that lists the various KPIs that are being measured in connection with the feedback provided by the reviewer. The table may also list the strategic objective of each KPI.

### VII. Feedback Based on Historical Data

As explained above, a computing system that monitors workflows may collect and store historical data that may be indicative of implementations of the workflows, perhaps over a particular period of time. The historical data may include a description of operations of the workflow that have been performed by agents. Additionally and/or alternatively, the historical data may include a description of the agents' performances of the operations. In an example, such data may include analytical data that describes the agents' performances. In another example, the data may include feedback that was provided to the agents in connection with the operations of the workflows.

In an embodiment, the historical data may be used to generate feedback for agents of the managed network. Specifically, in a process referred to as data mining, the historical data may be analyzed to generate new information about at least one of the agents' performances of operations, the agents' skill levels, and the informational resources available to the managed network. Then, feedback to agents may be generated based on the new information.

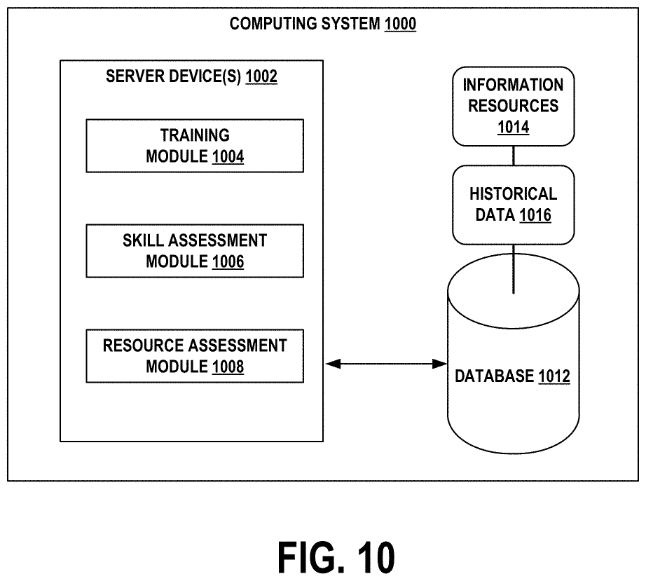

FIG. 10 depicts a block diagram of a computing system 1000, according to an example embodiment. As shown in FIG. 10, the computing system 1000 may include server device(s) 1002 and a database 1012. The database 1012 may store information resources 1014 and historical data 1016. In an example, the information resources 1014 and the historical data 1016 may respectively be similar to the information resources 716 and the historical data 718, as illustrated and described in reference to FIG. 7A.

The server device(s) 1002 may contain or may otherwise have access to program instructions executable by processor(s), so as to cause the computing system 1000 to carry out various operations described herein. On this point, the server device(s) 1002 may include server device(s) disposed within a computational instance of a remote network management platform, such as computational instance 322 of remote network management platform 320, and/or may include server device(s) disposed within a managed network (e.g., managed network 300). Thus, the various operations described herein could be carried out by just one server device and/or could be distributed among two or more of server devices in any feasible manner. As such, the computing system 1000 could include features and/or components of a managed network and/or of a remote network management platform that supports remote management of the managed network.

In an embodiment, the server device(s) 1002 may be configured to host and execute feedback modules for mining the historical data 1016 for new information and/or for generating feedback based on the new information. In particular, as shown in FIG. 10, the server device(s) 1002 may be configured to host and execute a plurality of modules including training module 1004, skill assessment module 1006, and/or resource assessment module 1008.

In an embodiment, the training module 1004 may mine the historical data 1016 in order to identify performance patterns that do not align with practice guidelines for the managed network. In an implementation, the training module 1004 may use anomaly detection in order to identify the performance patterns that deviate from the practice guidelines. In particular, various techniques may be used for the anomaly detection, such as statistical methods and/or machine learning based-approaches. More specifically, the machine learning-based approaches may include using classifiers, support vector machines, density-based anomaly detection, and clustering-based anomaly detection.

The training module 1004 may use the identified performance patterns to generate feedback for the users of the managed network. In an example, the training module 1004 may provide the users of the managed network with training information that may provide the users with the necessary training to perform assigned operations in-line with the practice guidelines. The training information may include one or more resources of the information resources 1014.

In an embodiment, the skill assessment module 1006 may mine the historical data 1016 in order to perform a skills gap analysis of skills of the users of the managed network. To determine a skills gap of the users, the historical data 1016 may be mined in order to first determine “current skills” of the users (e.g., skills in which the users have demonstrated expertise). In an implementation, the current skills of the users may be determined using clustering and normalization machine learning models. Based on the current skills of the users and the skills needed to perform work items in the managed network, the skill assessment module 1006 may determine a skills gap in the skills and/or knowledge of the users. For example, the skills gap may be calculated according to the following formula: Skills gap=Desired skills (i.e., skills needed to perform work items)−Current skills.

Based on the determined skills gap, the skill assessment module 1006 may generate feedback for the users. In an example, the skill assessment module 1006 may identify one or more users that need additional training in order to bridge the skills gap. In another example, the skill assessment module 1006 may recommend a new hire to bridge the skills gap.

In an embodiment, the resource assessment module 1008 may mine the historical data 1016 in order to assess the effectiveness of the informational resources 1014 of the managed network. In one example, the module 1008 may use a machine learning based recommendation engine in order to recommend learning content based on the best practices and on the users' individual performances against goals. In another example, the module 1008 may use machine learning ranking models to periodically evaluate and assign an effectiveness rating for the learning resources of the managed network, perhaps based on the frequency of use and/or based on whether user performance improved after using the resources.

### VIII. Example Operations

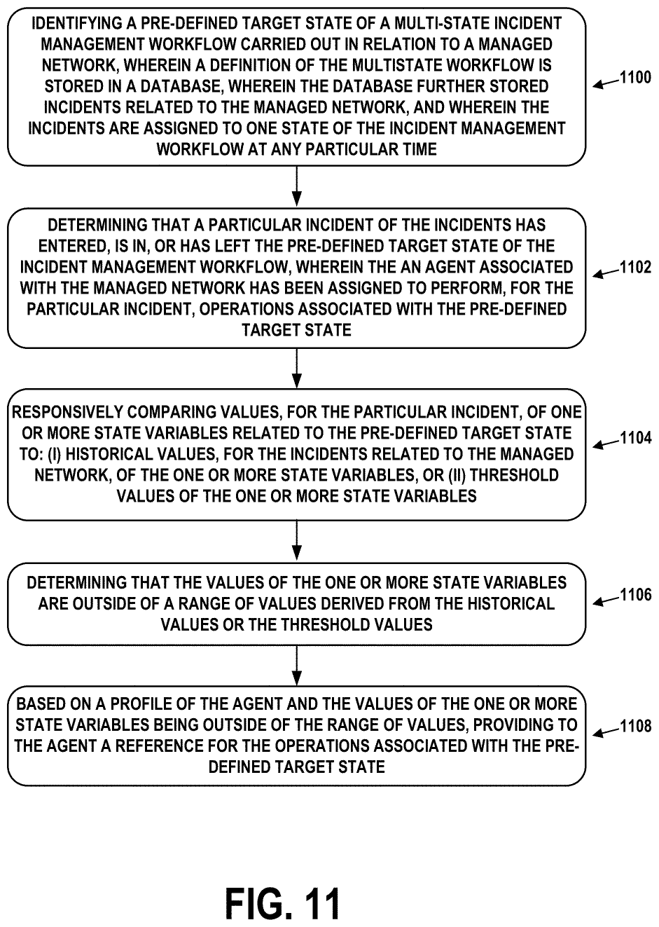

FIG. 11 is a flow chart illustrating an example embodiment. The process illustrated by FIG. 11 may be carried out by a computing device, such as computing device 100, and/or a cluster of computing devices, such as server cluster 200. However, the process can be carried out by other types of devices or device subsystems. For example, the process could be carried out by a portable computer, such as a laptop or a tablet device.

The embodiments of FIG. 11 may be simplified by the removal of any one or more of the features shown therein. Further, these embodiments may be combined with features, aspects, and/or implementations of any of the previous figures or otherwise described herein.

Block 1100 may involve identifying a pre-defined target state of a multi-state incident management workflow carried out in relation to a managed network, wherein a definition of the multi-state incident management workflow is stored in a database, wherein the database further stores incidents related to the managed network, and wherein the incidents are assigned to one state of the incident management workflow at any particular time.

Block 1102 may involve determining that a particular incident of the incidents has entered, is in, or has left the pre-defined target state of the incident management workflow, wherein an agent associated with the managed network has been assigned to perform, for the particular incident, operations associated with the pre-defined target state.

Block 1104 may involve responsively comparing values, for the incident, of one or more state variables related to the pre-defined target state to: (i) historical values, for the incidents related to the managed network, of the one or more state variables, or (ii) threshold values of the one or more state variables.

Block 1106 may involve determining that the values of the one or more state variables are outside of a range of values derived from the historical values or the threshold values.

Block 1108 may involve, based on a profile of the agent and the values of the one or more state variables being outside of the range of values, providing to the agent a reference to information that represents pre-defined practice guidelines for the operations associated with the pre-defined target state.

In some embodiments, a computing system may carry out the process of blocks 1100-1108. In some embodiments, one or more server devices of the computing system may carry out the process of blocks 1100-1108.

In some embodiments, a first state variable of the one or more state variables stores a length of time spent in the pre-defined target state, and wherein determining that the values of the one or more state variables are outside of a range of values derived from the historical values or the threshold values comprises based on the first state variable, determining that the length of time spent in the pre-defined target state is outside the range of values derived from the historical values or the threshold values.

In some embodiments, a first state variable of the one or more state variables is for storing a value of an input provided by the agent.

In some embodiments, determining that the values of the one or more state variables are outside of a range of values derived from the historical values or the threshold values comprises based on the first state variable, determining that the agent has not provided the input or that the value of the input is outside of the range of values derived from the historical values or the threshold values.

In some embodiments, a first state variable of the one or more state variables is for storing a proposed solution for the particular incident, and determining that the values of the one or more state variables are outside of a range of values derived from the historical values or the threshold values comprises: based on the historical values, determining that the proposed solution for the particular incident has not resolved incidents of a same type as the particular incident.

In some embodiments, determining that a particular incident of the incidents has entered, is in, or has left a pre-defined target state of the incident management workflow further comprises determining that the particular incident satisfies one or more pre-determined conditions.

In some embodiments, the one or more pre-determined conditions comprise: a threshold incident priority level and that the agent is one of a plurality of supervised agents.

In some embodiments, the information that represents pre-defined practice guidelines for the operations associated with the pre-defined target state comprises: (i) instructional media describing the pre-defined practice guidelines, (ii) instructional documents describing the pre-defined practice guidelines, and (iii) a guided training course that provides training on the pre-defined practice guidelines.

In some embodiments, the profile of the agent comprises (i) one or more areas of expertise of the agent, (ii) training received by the agent, and (iii) historical feedback data indicative of performances, by the agent, of the operations associated with a plurality of previously assigned pre-defined target states.

In some embodiments, the method further comprises: generating an assessment record indicative of the values of the one or more state variables; assigning the assessment record to a reviewer, associated with the managed network, that is responsible for providing feedback to the agent; receiving from the reviewer feedback on a performance, by the agent, of the operations associated with the pre-defined target state; and providing to the agent the feedback on the performance of the operations associated with the pre-defined target state.

In some embodiments, the method further comprises: providing, to a reviewer device, a representation of a graphical user interface that includes: (i) a first section, (ii) a second section, and (iii) a third section, where the first section includes information from the assessment report, where the second section includes values of the one or more state variables, and where the third section includes a feedback field enabling entry of a feedback description to the agent, and a menu enabling selection from one or more recommended corrective measures for the agent; receiving, by way of the graphical user interface and from the reviewer device, (i) the feedback description entered in the feedback field, and (ii) a selection, from the menu, of one or more of the corrective measures for the agent; and providing to the agent with the feedback description and the recommended corrective measure.

In some embodiments, the information from the assessment report comprises a unique identifier of the assessment report, a profile of the agent, and a due date for providing the agent with the reference to the information that represents the one or more of the corrective measures.

In some embodiments, the recommended corrective measure comprises at least one of: (i) instructional media indicative of best practices associated with the multi-state workflow, (ii) instructional documents indicative of the best practices, and (iii) a guided training course that provides training on the best practices.

In some embodiments, the menu is a first menu, and the third section further comprises: a second menu enabling selection from one or more quality of performance levels for the agent, and where receiving, by way of the graphical user interface and from the reviewer device, (i) the feedback description entered in the feedback field, and (ii) a selection, from the menu, of one or more of the corrective measures for the agent further comprises receiving by way of the graphical user interface and from the reviewer device, (iii) a selection, from the second menu, of one of the quality of performance levels for the agent.

In some embodiments, the historical values include records of previously resolved incidents and performance metrics associated with the resolved incidents, and where the method further comprises providing, to a reviewer device, a representation of a graphical user interface that includes one or more representations of the historical data, wherein the one or more representations include at least one of a pie chart and a graph.

### IX. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid state drive, or another storage medium.

The computer readable medium can also include non-transitory computer readable media such as computer readable media that store data for short periods of time like register memory and processor cache. The computer readable media can further include non-transitory computer readable media that store program code and/or data for longer periods of time. Thus, the computer readable media may include secondary or persistent long term storage, like ROM, optical or magnetic disks, solid state drives, compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A computational instance of a remote network management platform, the computational instance comprising:
a database storing: (i) a definition of a multi-state incident management workflow carried out in relation to a managed network, and (ii) incidents related to the managed network, wherein the incidents are assigned to one state of the incident management workflow at any particular time, and wherein the computational instance is dedicated to the managed network; and
one or more computing devices configured to:
determine that a particular incident of the incidents has entered, is in, or has left a pre-defined target state of the incident management workflow, wherein an agent associated with the managed network has been assigned to perform, for the particular incident, operations associated with the pre-defined target state;
responsively compare values, for the particular incident, of one or more state variables related to the pre-defined target state to: (i) historical values, for the incidents related to the managed network, of the one or more state variables, or (ii) threshold values of the one or more state variables;
determine that the values of the one or more state variables are outside of a range of values derived from the historical values or the threshold values; and
based on a profile of the agent and the values of the one or more state variables being outside of the range of values, provide to the agent a reference to information that represents pre-defined practice guidelines for the operations associated with the pre-defined target state.

2. The computational instance of claim 1, wherein a first state variable of the one or more state variables stores a length of time spent in the pre-defined target state, and wherein determining that the values of the one or more state variables are outside of a range of values derived from the historical values or the threshold values comprises the one or more computing devices configured to:
based on the first state variable, determine that the length of time spent in the pre-defined target state is outside the range of values derived from the historical values or the threshold values.

3. The computational instance of claim 1, wherein a first state variable of the one or more state variables is for storing a value of an input provided by the agent.

4. The computational instance of claim 3, wherein determining that the values of the one or more state variables are outside of a range of values derived from the historical values or the threshold values comprises:
based on the first state variable, determining that the agent has not provided the input or that the value of the input is outside of the range of values derived from the historical values or the threshold values.

5. The computational instance of claim 1, wherein a first state variable of the one or more state variables is for storing a proposed solution for the particular incident, and wherein determining that the values of the one or more state variables are outside of a range of values derived from the historical values or the threshold values comprises:
based on the historical values, determining that the proposed solution for the particular incident has not resolved incidents of a same type as the particular incident.

6. The computational instance of claim 1, wherein determining that the particular incident has entered, is in, or has left a pre-defined target state of the incident management workflow further comprises:
determining that the particular incident satisfies one or more pre-determined conditions, the one or more pre-determined conditions comprising: a threshold incident priority level and that the agent is one of a plurality of supervised agents.

7. The computational instance of claim 1, wherein the information that represents pre-defined practice guidelines for the operations associated with the pre-defined target state comprises: (i) instructional media describing the pre-defined practice guidelines, (ii) instructional documents describing the pre-defined practice guidelines, and (iii) a guided training course that provides training on the pre-defined practice guidelines.

8. The computational instance of claim 1, wherein the one or more computing devices are further configured to generate an assessment report indicative of the profile of the agent and the values of the one or more state variables.

9. The computational instance of claim 8, wherein the one or more computing devices are further configured to:
provide, to a reviewer device, a representation of a graphical user interface that includes: (i) a first section, (ii) a second section, and (iii) a third section,
wherein the first section includes information from the assessment report,
wherein the second section includes values of the one or more state variables, and
wherein the third section includes a feedback field enabling entry of a feedback description to the agent, and a menu enabling selection from one or more recommended corrective measures for the agent;
receive, by way of the graphical user interface and from the reviewer device, (i) the feedback description entered in the feedback field, and (ii) a selection, from the menu, of one or more of the corrective measures for the agent; and
provide to the agent with the feedback description and the recommended corrective measure.

10. The computational instance of claim 9, wherein the information from the assessment report comprises a unique identifier of the assessment report, a profile of the agent, and a due date for providing the agent with the reference to the information that represents the one or more of the corrective measures.

11. The computational instance of claim 9, wherein the recommended corrective measure comprises at least one of: (i) instructional media indicative of best practices associated with the multi-state workflow, (ii) instructional documents indicative of the best practices, and (iii) a guided training course that provides training on the best practices.

12. The computational instance of claim 9, wherein the menu is a first menu, wherein the third section further comprises: a second menu enabling selection from one or more quality of performance levels for the agent, and wherein receiving, by way of the graphical user interface and from the reviewer device, (i) the feedback description entered in the feedback field, and (ii) a selection, from the menu, of one or more of the corrective measures for the agent further comprises:
receiving by way of the graphical user interface and from the reviewer device, (iii) a selection, from the second menu, of one of the quality of performance levels for the agent.

13. The computational instance of claim 1, wherein the historical values include records of previously resolved incidents and performance metrics associated with the resolved incidents, and wherein one or more computing devices are further configured to:
provide, to a reviewer device, a representation of a graphical user interface that includes one or more representations of the historical data, wherein the one or more representations include at least one of a pie chart and a graph.

14. A computer-implemented method comprising:
identifying, by a computing system, a pre-defined target state of a multi-state incident management workflow carried out in relation to a managed network, wherein a definition of the multi-state incident management workflow is stored in a database, wherein the database further stores incidents related to the managed network, and wherein the incidents are assigned to one state of the incident management workflow at any particular time;
determining, by the computing system, that a particular incident of the incidents has entered, is in, or has left the pre-defined target state of the incident management workflow, wherein an agent associated with the managed network has been assigned to perform, for the particular incident, operations associated with the pre-defined target state;
responsively comparing, by the computing system, values, for the incident, of one or more state variables related to the pre-defined target state to: (i) historical values, for the incidents related to the managed network, of the one or more state variables, or (ii) threshold values of the one or more state variables;
determining, by the computing system, that the values of the one or more state variables are outside of a range of values derived from the historical values or the threshold values; and
based on a profile of the agent and the values of the one or more state variables being outside of the range of values, providing, by the computing system, to the agent a reference to information that represents pre-defined practice guidelines for the operations associated with the pre-defined target state.

15. The computer-implemented method of claim 14, wherein a first state variable of the one or more state variables stores a length of time spent in the pre-defined target state, and wherein determining, by the computing system, that the values of the one or more state variables are outside of a range of values derived from the historical values or the threshold values comprises:
based on the first state variable, determining, by the computing system, that the length of time spent in the pre-defined target state is outside the range of values derived from the historical values or the threshold values.

16. The computer-implemented method of claim 14, wherein a first state variable of the one or more state variables is for storing a proposed solution for the particular incident, and wherein determining that the values of the one or more state variables are outside of a range of values derived from the historical values or the threshold values comprises:
based on the historical values, determining, by the computing system, that the proposed solution for the particular incident has not resolved incidents of a same type as the particular incident.

17. The computer-implemented method of claim 14, further comprising:
generating, by the computing system, an assessment report indicative of the profile of the agent and the values of the one or more state variables;
providing, to a reviewer device, by the computing system, a representation of a graphical user interface that includes: (i) a first section, (ii) a second section, and (iii) a third section,
wherein the first section includes information from the assessment report,
wherein the second section includes values of the one or more state variables, and
wherein the third section includes a feedback field enabling entry of a feedback description to the agent, and a menu enabling selection from one or more recommended corrective measures for the agent;
receiving, by way of the graphical user interface and from the reviewer device, (i) the feedback description entered in the feedback field, and (ii) a selection, from the menu, of one or more of the corrective measures for the agent; and
providing, by the computing system, to the agent with the feedback description and the recommended corrective measure.

18. An article of manufacture including a non-transitory computer-readable medium, having stored thereon program instructions that, upon execution by a computing system, cause the computing system to perform operations comprising:
identifying a pre-defined target state of a multi-state incident management workflow carried out in relation to a managed network, wherein a definition of the multi-state incident management workflow is stored in a database, wherein the database further stores incidents related to the managed network, and wherein the incidents are assigned to one state of the incident management workflow at any particular time;
determining that a particular incident of the incidents has entered, is in, or has left the pre-defined target state of the incident management workflow, wherein an agent associated with the managed network has been assigned to perform, for the particular incident, operations associated with the pre-defined target state;
responsively comparing values, for the particular incident, of one or more state variables related to the pre-defined target state to: (i) historical values, for the incidents related to the managed network, of the one or more state variables, or (ii) threshold values of the one or more state variables;
determining that the values of the one or more state variables are outside of a range of values derived from the historical values or the threshold values; and
based on a profile of the agent and the values of the one or more state variables being outside of the range of values, providing to the agent a reference to information that represents pre-defined practice guidelines for the operations associated with the pre-defined target state.

19. The article of manufacture of claim 18, wherein a first state variable of the one or more state variables is for storing a value of an input provided by the agent.

20. The article of manufacture of claim 19, wherein determining that the values of the one or more state variables are outside of a range of values derived from the historical values or the threshold values comprises:
based on the first state variable, determining that the agent has not provided the input or that the value of the input is outside of the range of values derived from the historical values or the threshold values.
